(19) United States
(12) Patent Application Publication
(10) Pub. No.: US 2026/0049759 A1
(43) Pub. Date: Feb. 19, 2026

(54) REFRIGERATOR

(71) Applicant: LG ELECTRONICS INC., Seoul (KR)

(72) Inventor: Sanghyun CHEON, Seoul (KR)

(21) Appl. No.: 18/996,108

(22) PCT Filed: Jul. 4, 2023
(86) PCT No.: PCT/KR2023/009431

§ 371 Date: Jan. 17, 2025

(30) Foreign Application Priority Data
Jul. 20, 2022 (KR) 10-2022-0089506
Jul. 29, 2022 (KR) 10-2022-0094308
Nov. 9, 2022 (KR) 10-2022-0148894
Nov. 30, 2022 (KR) 10-2022-0164598

(51) Int. Cl. F25D 27/00; F25D 23/02; F25D 23/06; G02F 1/167; G02F 1/1677; G09F 9/33; G09F 23/00

(52) U.S. Cl. CPC F25D 27/00; F25D 23/028; F25D 23/062; G02F 1/1677; G09F 9/33; G09F 23/0058; G02F 1/167

(57) ABSTRACT

The present invention relates to a refrigerator comprising: a cabinet in which a storage space is formed; and a door for opening and closing the cabinet. The door includes: a door body; and a panel assembly that is mounted to the door body and forms the front of the door. The panel assembly includes: a panel that forms the front of the door; and a lighting assembly that is provided behind the panel and emits light toward the panel.

### TECHNICAL FIELD

The present disclosure relates to a refrigerator.

### BACKGROUND ART

In general, home appliances are disposed indoors and can be disposed so as to be in harmony with the surrounding space. In addition, in order to further improve the outer appearance of these home appliances, a panel forming the outer appearance can be provided on the front surface of the home appliance.

For example, refrigerators are being developed with structures that vary the outer appearance of the front surface to ensure harmony with the environment in which the refrigerators are disposed, surrounding furniture, or other home appliances, and this trend is being followed across home appliances.

Conventional refrigerators are configured to have panels of various colors installed on the front surface of the door, allowing the outer appearance of the front surface of the refrigerator to be expressed in various ways. In addition, the panels can be made of various materials such as glass, plastic, and metal.

However, in structures like this, there is a problem that the panel must be removed every time so that the outer appearance of the refrigerator is changed. In addition, there is a problem that the cost of replacing the panel is high.

### DISCLOSURE

### Technical Problem

An object of the present disclosure is to provide a refrigerator whose the color of the outer appearance of the panel can be changed.

An object of the present disclosure is to provide a refrigerator in which the color of the outer appearance of a metal door can be selectively changed.

An object of the present disclosure is to provide a refrigerator in which light can be transmitted through microscopic holes formed in an opaque panel to change and display the color of the front surface of the door.

An object of the present disclosure is to provide a refrigerator whose outer appearance design can be changed without replacing the outer appearance panel by changing the outer appearance design using an electrophoretic display (EPD) panel.

### Technical Solution

According to one embodiment of the present disclosure, a refrigerator for solving the above problem includes a cabinet forming a storage space; and a door opening and closing the cabinet; in which the door includes a door body; and a panel assembly mounted on the door body to form a front surface of the door, and the panel assembly includes a panel forming the front surface of the door; and a lighting assembly provided at a rear of the panel and irradiating light toward the panel.

The panel may be an electrophoretic panel, and the panel may include a panel main body forming the front surface of the door, and a panel connector connecting the panel main body and a controller.

The door body may be formed with an opening at the front, and a door body connector electrically connected to the panel connector may be provided in the opening.

The panel assembly may include a back cover forming a rear surface of the panel assembly, and the back cover covers the opened front surface of the door body.

A transparent panel that allows light to pass through may be provided between the panel and the lighting assembly.

The lighting assembly may include a base formed in a size corresponding to the electrophoretic panel and composed of at least one film layer; and
a plurality of light sources disposed on the base and irradiating light toward the electrophoretic panel; and the lighting assembly may adjust at least one of the color, brightness, and chroma of the front surface of the door when the electrophoretic panel is turned on.

The panel may be made of a metal material and includes a plurality of through-holes disposed spaced apart from each other, and the light irradiated from the lighting assembly may pass through the through-holes.

The lighting assembly may include a plate-shaped substrate disposed at a rear of the panel; and
A plurality of LEDs provided on a front surface of the substrate and disposed toward a rear surface of the panel, and the LEDs may be provided in a number corresponding to positions corresponding to the through-holes.

A guide member may be formed between the panel and the lighting device, and a front surface of the guide member may be in contact with the rear surface of the panel, and a rear surface of the guide member may be in contact with the front surface of the substrate, thereby maintaining a gap between the panel and the lighting device.

The guide member may be provided with a hole formed through which the LED is accommodated, and the through-hole, the hole, and the LED may be disposed on a same extension line.

A fixing member may be provided on the rear surface of the panel, a substrate fixing protrusion protruding backward may be formed on the fixing member, and a substrate hole through which the substrate fixing protrusion penetrates may be formed on the substrate to restrain the substrate.

The panel assembly may further include a light guide plate provided at the rear of the panel and guiding light toward the panel, and the lighting assembly may be configured to irradiate light toward an end part of the light guide plate by being spaced apart from at least one side of a perimeter surface of the light guide plate.

The panel assembly may include a plurality of holders disposed along a periphery of the light guide plate and accommodating the end part of the light guide plate to fix the light guide plate, the lighting assembly may be accommodated inside the holder, the holder may be formed of a different material having a different thermal expansion coefficient from that of the light guide plate, and the plurality of holders may be disposed spaced apart from each other.

The holder may be formed with a fixing protrusion extending rearwardly so as to pass through a rear surface of the panel assembly, and the fixing protrusion may be coupled with a holder bracket provided on the door body when the panel assembly is mounted on the door body.

A diffusion sheet may be attached to the rear surface of the panel, the diffusion sheet may be formed to shield all of the plurality of through-holes, and the inside of the through-holes may be filled with a hole-filling member that allows light to pass through.

### Advantageous Effect

The refrigerator according to the proposed embodiment can be expected to have the following effects.

In a refrigerator according to an embodiment of the present disclosure, the color of the outer appearance of the panel can be changed by light irradiated from a lighting device at the rear of the panel while the panel is mounted. Therefore, there is an advantage in that the outer appearance of the door can be changed to a color desired by the user even while the panel is mounted.

In addition, the panel can be formed of an opaque material such as metal, and the color of the outer appearance of the panel made of the opaque material can be changed by allowing light to pass through the microscopic through-holes formed in the panel. In particular, when the panel is formed of a metal material, the texture unique to metal can be maintained when the lighting device is turned off, and the color of the outer appearance of the panel can be changed when the lighting device is turned on.

In addition, the penetration holes are formed in a microscopic size, and a coating layer is formed on the front surface of the panel so that the penetration holes are not visible when the lighting device is turned off, thereby maintaining the outer appearance of a metallic texture.

In addition, by controlling the on/off or color change of the LED corresponding to the through-hole, videos, images, text, or the like can be output through the numerous minute through-holes formed on the front surface of the panel. Therefore, there is an advantage in that the entire front surface of the refrigerator door can function as a display.

In addition, the lighting device can be fixed in mounting position by a fixing member inside the door, and the through-hole, the hole of the guide member, and the LED are aligned to ensure light irradiation through each through-hole, and there is an advantage in that outer appearance defects can be prevented.

According to a refrigerator according to an embodiment of the present disclosure, the outer appearance design can be changed without replacing the outer appearance panel by changing the outer appearance design using an electrophoretic display (EPD) panel. Accordingly, various colors and patterns can be displayed on the outer appearance of the refrigerator with low power.

According to a refrigerator according to an embodiment of the present disclosure, the outer appearance design can be improved by supplementing the color and brightness of the front surface of the door using a lighting device. Therefore, there is an advantage in that the brightness of outer appearance of the front surface of the door can be adjusted while simultaneously adjusting the chroma and brightness.

### DESCRIPTION OF DRAWINGS

FIG. 1 is a front view illustrating a refrigerator according to an embodiment of the present disclosure.

FIG. 2 is a front view illustrating the refrigerator with the door open.

FIG. 3 is a perspective view illustrating the door.

FIG. 4 is an exploded perspective view illustrating the panel assembly, which is the main component of the door, and the door body separated

FIG. 5 is an exploded perspective view illustrating a state where the panel assembly is exploded, as seen from the front.

FIG. 6 is an exploded perspective view illustrating a state where the panel assembly is exploded, as seen from the rear.

FIG. 7 is a cross-sectional view taken along line B-B′ of FIG. 5 illustrating an example of the structure of a panel constituting the panel assembly.

FIG. 8 is an exploded perspective view illustrating the coupling structure of the panel and the fixed member.

FIG. 9 is a cross-sectional view taken along line B-B′ of FIG. 5 illustrating another example of the structure of a panel constituting the panel assembly.

FIG. 10 is an exploded perspective view illustrating the coupling structure of the panel and the fixed member.

FIG. 11 is a cross-sectional view taken along line A-A′ of FIG. 3.

FIG. 12 is a front view illustrating a state where the lighting device of the door is driven and the color of the front surface of the door has changed.

FIG. 13 is a front view illustrating a state where the lighting device of the door is driven and output is provided to the front surface of the door.

FIG. 14 is an exploded perspective view illustrating a panel assembly according to another embodiment of the present disclosure.

FIG. 15 is a cross-sectional view taken along line A-A′ of FIG. 3 in another embodiment of the present disclosure.

FIG. 16 is a cross-sectional view taken along line C-C′ of FIG. 4 in another embodiment of the present disclosure.

FIG. 17 is an exploded perspective view illustrating a state where the panel assembly and door body are separated.

FIG. 18 is an exploded perspective view illustrating a panel assembly according to another embodiment.

FIG. 19 is an exploded perspective view illustrating a panel assembly according to another embodiment.

FIG. 20 is an exploded perspective view illustrating a panel assembly according to another embodiment.

FIG. 21 is a block diagram illustrating the flow of control signals of a refrigerator.

FIG. 22 is a front view illustrating a state where the front color of the door has changed.

FIG. 23 is a front view illustrating a state where the emoticon set on the front surface of the door is output.

FIG. 24 is a perspective view illustrating a vacuum cleaner according to one embodiment.

FIG. 25 is a drawing illustrating an example of controlling the color of home appliances to which the panel assembly is applied using a remote device.

### BEST MODEL

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, or the like other components.

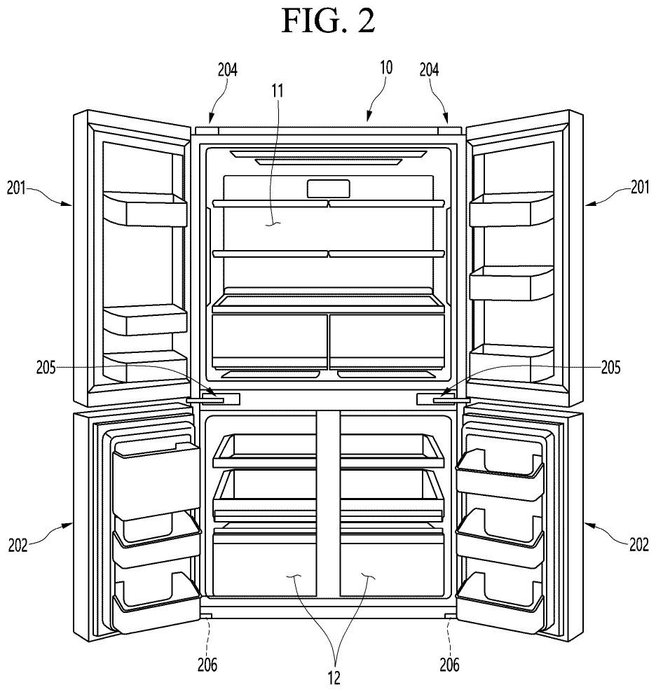

Before explanation, the direction is defined. In an embodiment of the present disclosure, the direction toward the door based on the cabinet illustrated in FIG. 2 can be defined as front, the direction toward the cabinet based on the door can be defined as rear, the direction toward the floor surface on which the refrigerator is installed can be defined as downward, and the direction away from the floor surface can be defined as upward.

The home appliances of the present disclosure may include refrigerators, air conditioners, air purifiers, vacuum cleaners, cooking appliances, dishwashers, clothes managers, washing machines, or the like. However, the types of home appliances are not limited to the examples, and any appliance installed in a user's home and helpful for the user's housework may be included without limitation.

First, we will describe the refrigerator as a type of home appliance, and the description of the refrigerator below can be applied to other types of home appliances as well.

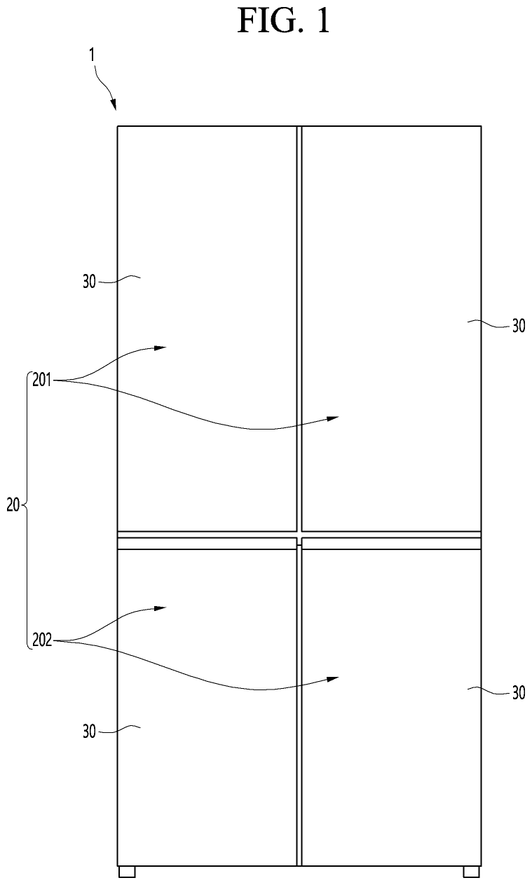

FIG. 1 is a front view illustrating a refrigerator according to an embodiment of the present disclosure, and FIG. 2 is a front view illustrating the refrigerator with the door open.

As illustrated, a refrigerator 1 according to an embodiment of the present disclosure may have an outer appearance formed by a cabinet 10 forming a storage space and a door 20 for opening and closing the storage space of the cabinet 10.

For example, the cabinet 10 may form a storage space divided into upper and lower parts, with a refrigerating compartment 11 formed at the upper part and a freezing compartment 12 formed at the lower part. The refrigerating compartment 11 may be referred to as an upper storage space, and the freezing compartment 12 may be referred to as a lower storage space.

The door 20 may be configured to open and close the refrigerating compartment 11 and the freezing compartment 12, respectively. The door 20 may include a refrigerating compartment door 201 for opening and closing the refrigerating compartment 11, and a freezing compartment door 202 for opening and closing the freezing compartment 12. In addition, a pair of refrigerating compartment doors 201 may be disposed side by side on the left and right sides, and each refrigerating compartment door 201 may partially open and close the refrigerating compartment 11. In addition, a pair of freezing compartment door 202 may be disposed side by side on the left and right sides, and may respectively open and close the freezing compartment 12 partitioned into the left and right sides. The refrigerating compartment door 201 may be referred to as an upper door since it is provided at the upper part of the cabinet 10, and the freezing compartment door 202 may be referred to as a lower door since it is provided at the lower part of the cabinet 10.

The door 20 can be rotatably mounted on the cabinet 10 by being connected by a hinge device 204, 205, 206, and can open and close the refrigerating compartment 11 and freezing compartment 12 respectively by rotation.

In this embodiment, for the convenience of explanation and understanding, a refrigerator having a structure in which a refrigerating compartment 11 is disposed at the top and a freezing compartment 12 is disposed at the bottom is described as an example, but the present disclosure is not limited to the shape of the refrigerator and can be applied to all types of refrigerators equipped with a door. In addition, the door 20 may be configured to open and close the storage space by pulling in and out.

Meanwhile, the door 20 forms the outer appearance of the front surface of the refrigerator 1 when closed, and can form the outer appearance of the refrigerator 1 seen from the front when the refrigerator 1 is installed.

The door 20 may have a structure in which the front surface can be selectively illuminated, and may be configured to glow with a set color or brightness. Accordingly, the user can manipulate the front surface color or brightness of the door 20 to change without separating or disassembling the door 20, and can change the overall outer appearance of the refrigerator 1.

Hereinafter, the structure of the door 20 will be examined in detail with reference to the drawings. In addition, the embodiment of the present disclosure will be described based on the refrigerating compartment door 201, and other doors may also have the same structure with only differences in the mounting position.

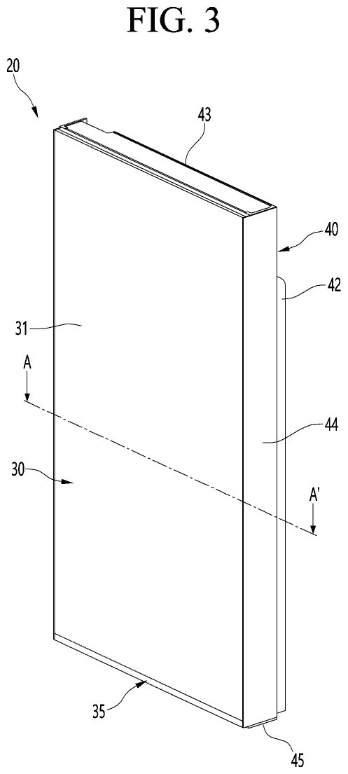

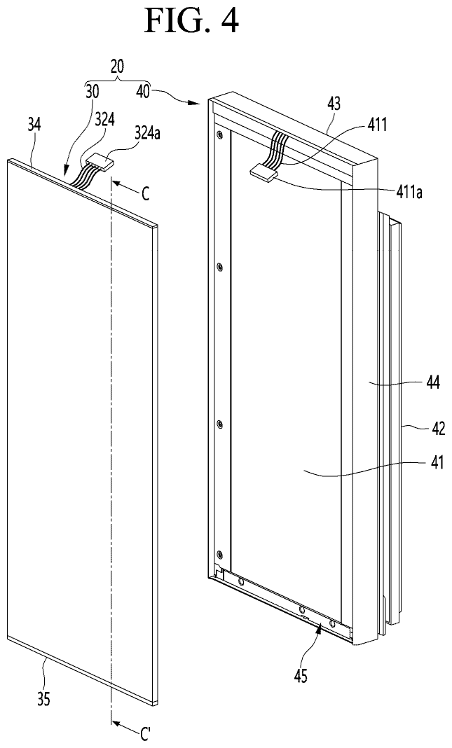

FIG. 3 is a perspective view illustrating the door, and FIG. 4 is an exploded perspective view illustrating the panel assembly, which is the main component of the door, and the door body separated.

As illustrated, the door 20 may include a door body 40 that forms the overall shape of the door 20 and opens and closes the storage space, and a panel assembly 30 that forms the outer appearance of the front surface of the door 20.

The door body 40 may include a door plate 41 forming the front and a door liner 42 forming the rear. In addition, the door body 40 may include a side decoration 44 forming left and right sides of the door body 21. The side decoration 44 may extend in the vertical direction, and an upper end may be coupled with an upper cap decoration 43 and a lower end may be coupled with a lower cap decoration 45. In addition, the door body 40 may further include an upper cap decoration 43 and a lower cap decoration 45 forming the upper and lower surfaces of the door body 40.

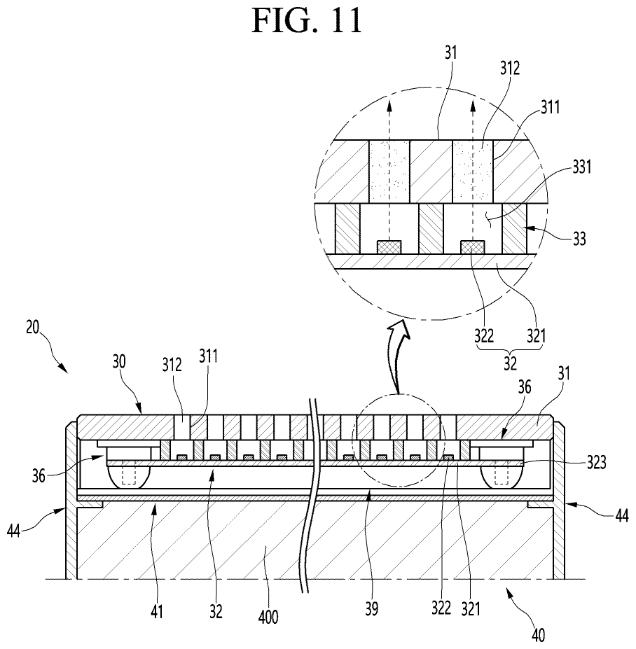

In other words, the outer appearance of the door body 40 can be formed by the door plate 41, the door liner 42, the side decoration 44, the upper cap decoration 43, and the lower cap decoration 45. In addition, a foaming liquid can be injected into the space inside the door body 40 formed by coupling the door plate 41, the door liner 42, the side decoration 44, the upper cap decoration 43, and the lower cap decoration 45 to form an insulation material 400 (in FIG. 11).

In addition, the front surface of the door body 40 can be recessed so that the panel assembly 30 can be accommodated. In addition, the perimeter of the door body 40 can be in contact with the perimeter surface of the panel assembly 30 to secure the panel assembly 30.

A structure for mounting the panel assembly 30 may be provided on the front surface of the door body 40. For example, the upper and lower ends of the panel assembly 30 may be coupled with the upper cap decoration 43 and the lower cap decoration 45. In addition, the panel assembly 30 may be detachably attached to the door body 40 while being assembled into one module. Accordingly, the lighting device 32 may be prevented from being damaged by the foaming heat generated during the molding of the insulation material 400, and the maintenance of the panel assembly 30 may be easy.

Meanwhile, the door plate 41 may be disposed to face the rear surface of the panel assembly 30. In addition, the rear surfaces of the door plate 41 and the panel assembly 30 may be spaced apart from each other by at least a part. In addition, the door body 40 and the panel assembly 30 may be provided with connecting lines 324, 411. A connector 324a, 411a may be provided at an end part of the connecting line 324, 411. Therefore, when the panel assembly 30 is detached, the connecting lines 324, 411 may be connected and separated from each other using the connector 324a, 411a. In a state where the connector 324a, 411a is connected, power may be supplied to the lighting device 32 of the panel assembly 30 and a signal may be transmitted.

The panel assembly 30 is formed in a plate shape and can form the outer appearance of the front surface of the door 20 when mounted on the front surface of the door body 40. The panel assembly 30 forms the outer appearance of the front surface of the door 20 and therefore can be referred to as a door panel, and can also be referred to as an outer appearance panel because it forms the outer appearance of the front surface of the refrigerator 1.

In this way, the panel assembly 30 may have a structure that can be detachably mounted from the door body 40 for service and maintenance.

The panel assembly 30 can form a substantial outer appearance of the front surface of the door 20 with its front surface exposed forward when mounted on the door body 40. In other words, the color of the outer appearance of the front surface of the door 20 can be determined by the color of the front surface of the panel assembly 30. In addition, the entire front surface of the panel assembly 30 can be configured to glow in a color designated by the user, and the color of the front surface of the door 20 can be expressed in various ways by changing to various colors selected by the user when the door 20 and the panel assembly 30 are mounted. In addition, the panel assembly 30 can also transmit information to the user in the form of a picture, text, image, video, or the like through a screen output.

Below, the structure of the panel assembly 30 will be examined in detail with reference to the drawings.

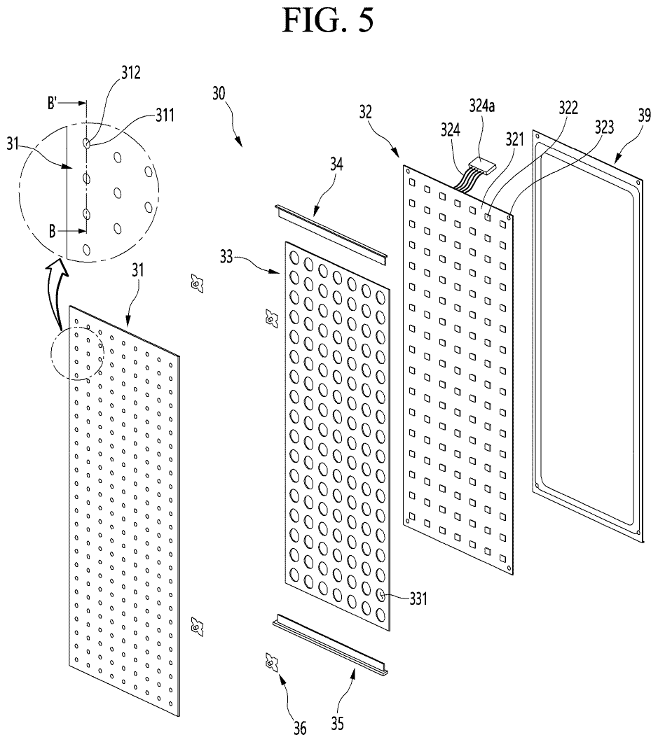

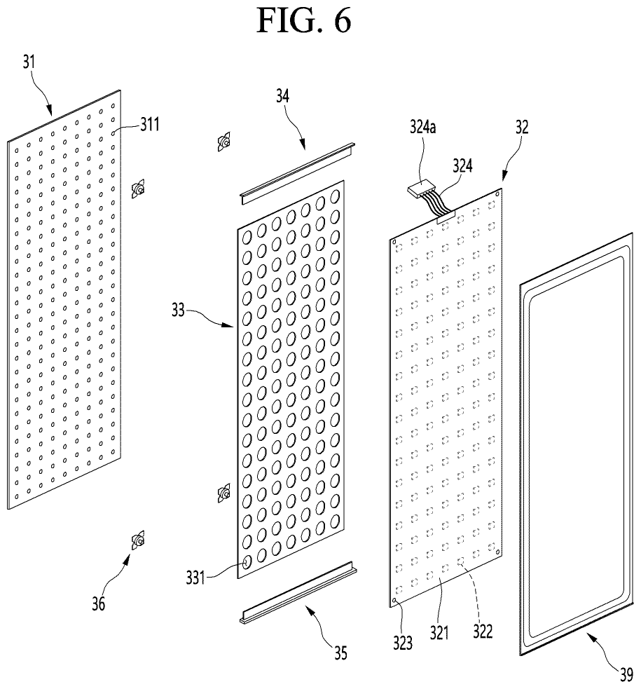

FIG. 5 is an exploded perspective view illustrating a state where the panel assembly is exploded, as seen from the front, and FIG. 6 is an exploded perspective view illustrating a state where the panel assembly is exploded, as seen from the rear.

As illustrated in the drawing, the panel assembly 30 may include a panel 31 forming a front surface, a lighting device 32 at the rear of the panel 31, and a back cover 39 forming a rear surface. In addition, a guide member 33 may be provided between the panel 31 and the lighting device 32.

The panel 31 may be formed in a rectangular plate shape. The panel 31 may form the outer appearance of the front surface of the panel assembly 30 and the door 20. The panel 31 may be formed of an opaque material. For example, the panel 31 may be formed of a stainless steel material. In addition, as another example, the panel 31 may be formed of various materials that are opaque and can form microscopic holes, such as metal, resin, ceramic, and FENIX. The panel 31 may be formed of a material that does not transmit light, and may be formed of various materials that can form microscopic through-holes 311 penetrating the panel 31.

In the panel 31, fine penetration holes 311 can be evenly formed over the entire area of the panel 31. The penetration holes 311 can be formed in a size that is not easily visible from a certain distance away from the panel 31.

An upper bracket 34 and a lower bracket 35 may be provided at the upper und and the lower end of rear surfaces of the panel 31. The upper bracket 34 and the lower bracket 35 may form the upper and lower surfaces of the panel assembly 30. In addition, the upper bracket 34 and the lower bracket may have a structure that is coupled and separated from the door body 40 when the panel assembly 30 is detached.

In addition, the panel assembly 30 may be provided with a fixing member 36 for fixing the lighting device 32. The fixing member 36 may enable the lighting device 32 to be mounted at an accurate position. In particular, the fixing member may enable the LED 322 of the lighting device 32 to be disposed in a state aligned with the through-hole 311 so that each LED 322 matches each through-hole 311 on a 1:1 basis.

In addition, a fixing display part 315 may be formed on the panel 31 so that the fixing member 36 can be mounted at an accurate position. By the fixing display part 315, the fixing member 36 can be positioned at an accurate position, and the lighting device 32 can also be fixedly mounted at an accurate position. In addition, the fixing member 36 may also fix a guide member 33 to be described below.

The fixed display part 315 and the fixed member 36 may be provided in multiple numbers. The fixed members 36 may be disposed at the four corners of the panel 31. As another example, the fixed members 36 may be mounted on the upper bracket 34 and the lower bracket 35. As another example, the fixed members 36 may be formed integrally with the upper bracket 34 and the lower bracket 35.

In addition, the lighting device 32 may be provided inside the panel assembly 30. The lighting device 32 may be referred to as an LED module. The lighting device 32 may be composed of a substrate 321 and an LED 322.

The substrate 321 may be formed in a rectangular plate shape. In addition, the substrate 321 may be disposed parallel to the panel 31 at the rear of the panel 31. In addition, the size of the substrate 321 may be formed larger than the area in which the plurality of through-holes 311 formed in the panel 31 are disposed.

In addition, a PCB hole may be formed in the substrate 321. The substrate hole 323 is formed at a position corresponding to the fixing member 36, and the fixing member 36 may be inserted to fix the substrate 321. A plurality of substrate holes 323 may be provided. The substrate holes 323 may be formed at four corners of the substrate 321.

In addition, the connecting line 324 can be connected to the substrate 321. The connecting line 324 can pass through the back cover 39 and be connected to the connecting line 411 of the door body 40. To this end, the connecting line 324, 411 can be provided with a connector 324a, 411a, and the panel assembly 30 and the door body 40 can be electrically connected to each other by the connector 324a, 411a.

An LED 322 may be disposed on the substrate 321. The LED 322 may be an RGB LED that emits light of various colors. The LED 322 may emit light of various colors by a user's manipulation. The LED 322 may be provided in a number corresponding to the through-hole 311. The LED 322 may be provided at a position facing the through-hole 311. An extension line of the center of the LED 322 and the center of the through-hole 311 may be located on the same extension line. The LED 322 is matched 1:1 with the through-hole 311, so that when the LED 322 is turned on, light may be irradiated by passing through the corresponding through-hole 311. The through-hole 311 and LED 322 illustrated in the drawing are drawn for convenience of explanation, and their size and ratio may differ from the actual ones, and their number may also differ.

When the LED 322 is turned off, the outer appearance of the front surface of the door 20 can be formed by the panel 31. In other words, the outer appearance of the front surface of the door 20 can be formed by the unique color and texture of the panel 31. At this time, the through-hole 311 may not be visible at a position that is a set distance away from the refrigerator 1.

In addition, when the LED 322 is turned on, the light irradiated from the LED 322 passes through the through-hole 311 and causes the front surface of the door 20 to glow. At this time, according to the color of the LED 322, the outer appearance of the front surface of the door 20 may appear in a set color. In addition, when the color of the light irradiated from the LED 322 is changed, the color of the front surface of the door 20 may also be changed.

The lighting device 32 is disposed at the rear of the panel 31 and can be spaced apart by a set gap. The lighting device 32 can be fixed while being spaced apart from the panel 31. In addition, the gap between the lighting device 32 and the panel 31 can be maintained by the fixing member 36.

A guide member 33 may be provided between the lighting device 32 and the panel 31. The front surface of the guide member 33 may be in contact with the panel 31 and the rear surface thereof may be in contact with the substrate 321. Therefore, the panel 31 and the lighting device 32 may be maintained at a certain distance by the guide member 33. In addition, even when the door 20 is repeatedly opened and closed, the panel 31 and the substrate 321 may be firmly fixed. In addition, the LED 322 is disposed inside the hole 331, so that even if an impact is applied to the panel assembly 30, the LED 322 does not come into contact with other components. In addition, the LED 322 may be prevented from being damaged by the guide member 33.

A plurality of holes 331 may be formed in the guide member 33. The holes 331 may be formed in a number corresponding to the number of through-holes 311 and LEDs 322. The holes 331 may be formed at positions corresponding to the LEDs 322 and the through-holes 311. In other words, the through-holes 311, the holes 331, and the LEDs 322 may be disposed continuously in the front and rear direction, and may be disposed on a same extension line, respectively.

In addition, the thickness of the guide member 33 can be formed thicker than the protrusion height of the LED 322. Therefore, due to the disposition of the guide member 33, the LED 322 inevitably does not come into contact with the panel 31 or the hole filling member 312.

In addition, the hole 331 may be formed so that the LED 322 is accommodated inside. For example, the hole 331 may be formed in a circular shape. In addition, the inner surface of the hole 331 may be formed so that the width increases as it goes forward, and may be formed so that the light irradiated from the LED 322 does not interfere.

The hole 331 may be formed so that the widths of the open front and rear surfaces are the same. In addition, as another example, the hole 331 may be formed so that the widths of the open front and rear surfaces are different from each other.

In other words, the width of the rear surface of the hole 331 is formed to be larger than the width of the LED 322 so that the LED 322 can be accommodated. In addition, the width of the front surface of the hole 331 may be formed to be larger than the width of the rear surface of the hole 331. At this time, the edge of the opened front surface of the hole 331 may be positioned outside the irradiation angle of the LED 322. Accordingly, it is possible to prevent the light irradiated from the LED 322 from being blocked by the guide member 33 or from being shaded.

Meanwhile, the guide member 33 may be formed of a material that allows light to pass through, and may be formed of a transparent or translucent material. Accordingly, even if some of the light irradiated from the LED 322 is directed to the guide member 33, it may pass through the guide member 33 and be directed to the panel 31. In addition, the guide member 33 may include an additive material, such as a diffusion agent, for diffusing the light irradiated from the LED 322, and the light directed to the panel 31 may be diffused so that the entire front surface of the panel 31 may glow with uniform brightness.

The back cover 39 may form the rear surface of the panel assembly 30. Therefore, the back cover 39 may be referred to as a rear plate. The back cover 39 may have a perimeter folded to form a perimeter surface of the panel assembly 30. The back cover 39 may be formed of a metal material. For example, the back cover 39 may be formed of a steel plate material. The back cover 39 may be directly or indirectly connected to the lighting device 32, and heat of the lighting device 32 may be dissipated through the back cover 39.

The back cover 39 can shield the internal components of the panel assembly 30. The back cover 39 can shield the lighting device 32 from the rear. The back cover 39 can be coupled and fixed with the upper bracket 34 and the lower bracket 35.

Meanwhile, the through-hole 311 of the panel 31 can be formed in various ways and can have various structures accordingly. Hereinafter, the formation structure of the through-hole 311 and the mounting structure of the fixing member 36 according to it will be examined.

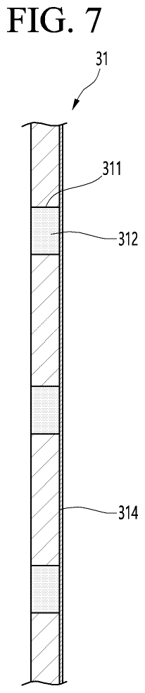

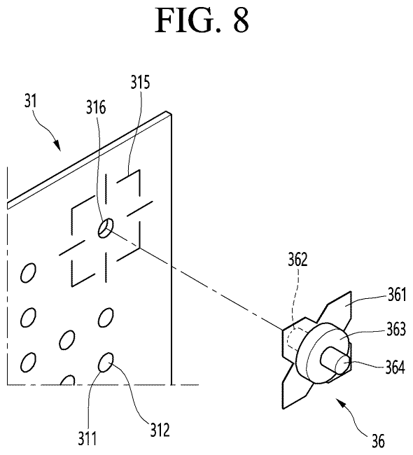

FIG. 7 is a cross-sectional view taken along line B-B′ of FIG. 5 illustrating an example of the structure of a panel constituting the panel assembly, and FIG. 8 is an exploded perspective view illustrating the coupling structure of the panel and the fixed member.

As illustrated, the panel 31 can form the through-hole 311 by a perforation method.

The through-hole 311 may be formed to a minute size so that it is difficult to identify from the outside when the LED 322 is turned off. For example, the through-hole 311 may be formed to have a diameter of 0.4 mm to 0.7 mm. Therefore, the through-hole 311 may be referred to as a micro through-hole. It is preferable that the through-hole 311 be formed to a size as small as possible so that it can have a uniform size. Of course, the size of the through-hole 311 may be formed to be more minute or somewhat larger according to the processing method.

First, looking at an example in which the through-hole 311 is formed by a perforation method, the panel 31 can be formed of a metal material. In addition, the through-hole 311 can be processed by a direct perforation method such as laser drilling, punching, or NCT (Numerically Controlled Turret) processing.

After the through-hole 311 is formed, the inside of the through-hole 311 can be filled with a hole-filling member 312. The hole-filling member may be referred to as a transparent material. The hole-filling member 312 may be formed of a material that allows light to pass through. For example, it may be formed of silicone or a resin material, and may be used to fill all of the plurality of through-holes 311 using a printing method.

Additionally, a clear coating layer may be further formed on the front surface of the panel 31 to protect the panel 31.

In addition, a diffusion sheet 314 may be attached to the rear surface of the panel 31 so that the light irradiated from the LED 322 can glow brighter and more uniformly.

Meanwhile, when the through-hole 311 is formed by a perforation method, a groove or a fixing hole 316 may be processed so that the fixing member 36 can be inserted into the position where the fixing member 36 is mounted. For example, the fixing hole 316 may be formed at the four corners of the panel 31. The fixing hole 316 may be perforated on the rear surface of the panel 31 and may be formed together during the molding of the through-hole 311.

In addition, a display part 315 may be formed on the rear surface of the panel 31 at a location where the fixing member 36 is disposed. The display part 315 is formed in a shape corresponding to the rear surface of the fixing member 36, and may be printed to accurately indicate the disposition of the fixing member 36. If necessary, both the display part 315 and the fixing hole 316 may be formed.

The fixing member 36 may be injection-molded from a plastic material, and may include a base part 361 fixed to the display part 315, and a support part 363 supporting the substrate 321. A panel fixing protrusion 362 inserted into a fixing hole 316 of the display part 315 may be formed on the base part 361. In addition, the support part 363 may include a substrate fixing protrusion 364 penetrating the substrate hole 323 of the substrate.

Accordingly, the panel 31 and the substrate 321 can be coupled to each other by the fixing member 36. In addition, the fixing member 36 can be positioned at an accurate position on the display part 315, thereby ensuring that the substrate 321 is mounted and that the LED 322 is aligned with the hole 331 and the through-hole 311.

In other words, when the substrate is mounted on the fixing member 36 mounted on the panel 31, the LED 322, the hole 331, and the through-hole 311 can be disposed in a straight line. Accordingly, the through-holes 311 of a microscopic size can all glow independently according to the on/off of the LED 322.

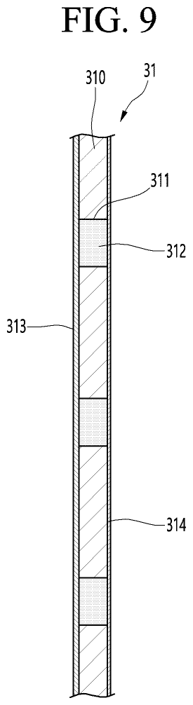

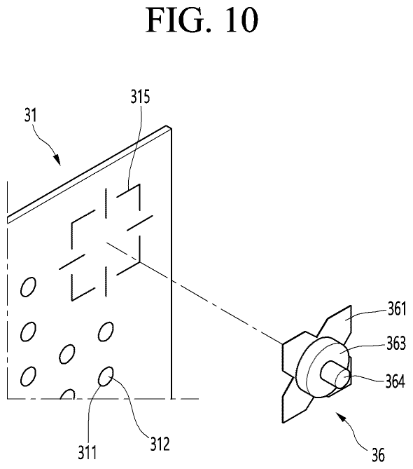

FIG. 9 is a cross-sectional view taken along line B-B′ of FIG. 5 illustrating another example of the structure of a panel constituting the panel assembly, and FIG. 10 is an exploded perspective view illustrating the coupling structure of the panel and the fixed member.

As illustrated, the panel 31 may also form the through-hole by etching.

The panel 31 may be formed as a metal plate capable of being etched. The panel 31 may be formed as a steel plate having a color coating layer 313 formed on the surface. For example, the panel may be formed as a VCM (Vinyl coated metal) steel plate. When the LED 322 is turned off, the through-hole 311 may be concealed by the color coating layer 313.

A through-hole 311 can be formed in the metal layer 310 of the panel 31 by etching. When forming the through-hole 311, the etching solution is made of a component that does not react with the color coating layer 313, so that the through-hole 311 can be formed only in the metal layer 310 of the panel 31.

In this state, the inside of the through-hole 311 can be filled with the hole filling member 312. At this time, the hole filling member 312 can be filled through the open rear surface of the through-hole 311.

The coating layer 313 may have a specific color as needed. Accordingly, when the LED 322 is turned off, the through-hole 311 may be covered by the color of the coating layer 313 and may not be visible from the outside. In other words, when the LED 322 is turned off, the outer appearance of the panel 31 may appear as if the through-hole 311 is not formed.

Meanwhile, when the through-hole 311 is formed by an etching method, the display part 315 can also be formed by etching. The display part 315 can be formed by etching at a position corresponding to the position where the fixing member 36 is disposed on the rear surface of the panel 31.

In addition, the fixing member 36 may include a base part 361 fixed to the display part 315 and a support part 363 supporting the substrate 321. The base part 361 is formed to have a size corresponding to the display part 315 and may be adhered to the rear surface of the panel 31 on which the display part 315 is formed. In addition, the support part 363 may include a substrate fixing protrusion 364 penetrating the substrate hole 323 of the substrate.

Accordingly, the substrate 321 can be coupled to the fixing member 36 while the panel 31 is adhered to the fixing member 36. In addition, the fixing member 36 is disposed at an accurate position on the display part 315, thereby ensuring not only the mounting of the substrate 321 but also the alignment of the LED 322 with the hole 331 and the through-hole 311.

Below, the operation of changing the state of the outer appearance of the front surface of a refrigerator 1 having the configuration will be described in more detail with reference to the drawings.

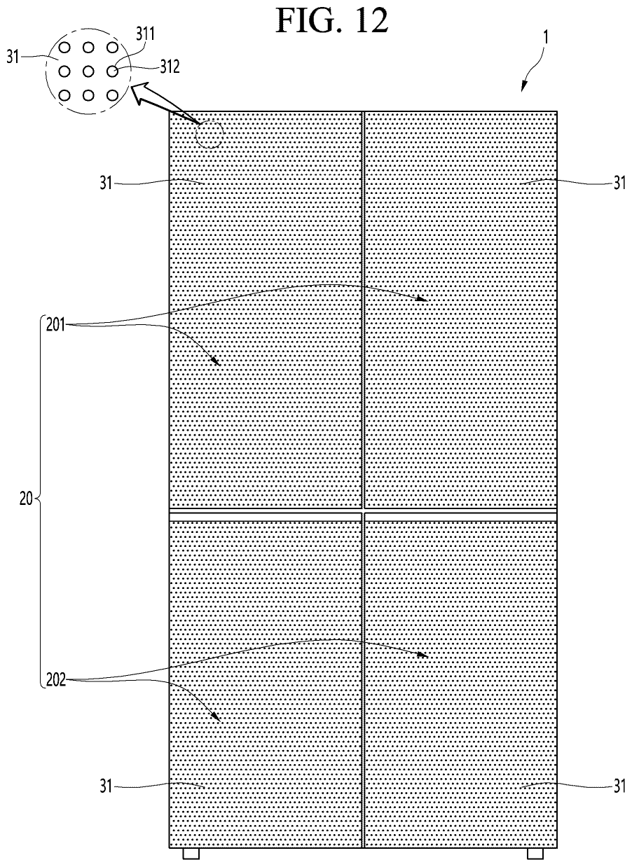

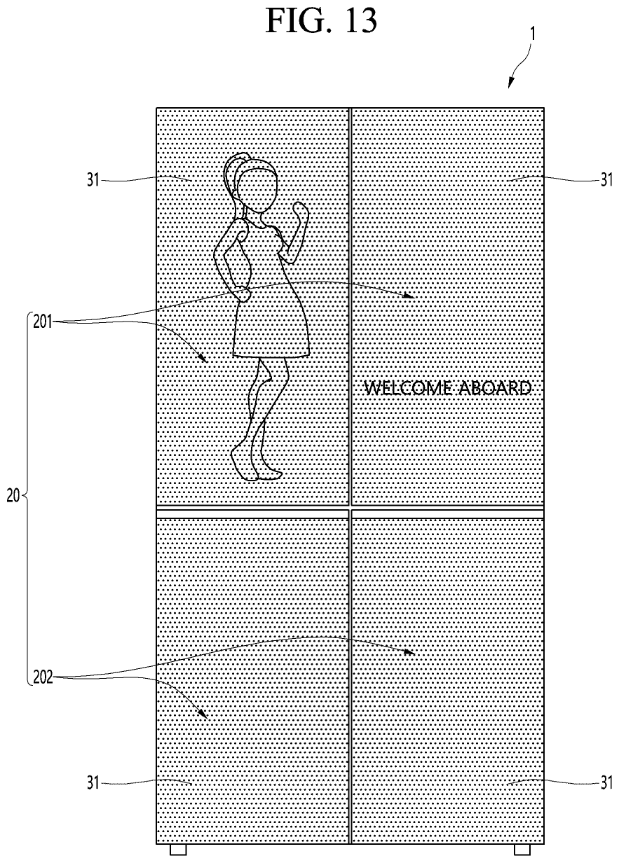

FIG. 11 is a cross-sectional view taken along line A-A′ of FIG. 3, FIG. 12 is a front view illustrating a state where the lighting device of the door is driven and the color of the front surface of the door has changed, and FIG. 13 is a front view illustrating a state where the lighting device of the door is driven and output is provided to the front surface of the door.

As illustrated in the drawing, when the lighting device 32 is turned off, the color of the outer appearance of the front surface can be expressed by the color of the panel 31. The color displayed on the panel 31 when the lighting device 32 is turned off can be referred to as the first color.

When the lighting device 32 is operated, the color of the panel 31 changes according to the color of the light irradiated from the lighting device 32, and the color of the outer appearance of the front surface of the door 20 can be expressed as a selected color. At this time, the color displayed through the panel by the light irradiated from the lighting device 32 can be referred to as a second color.

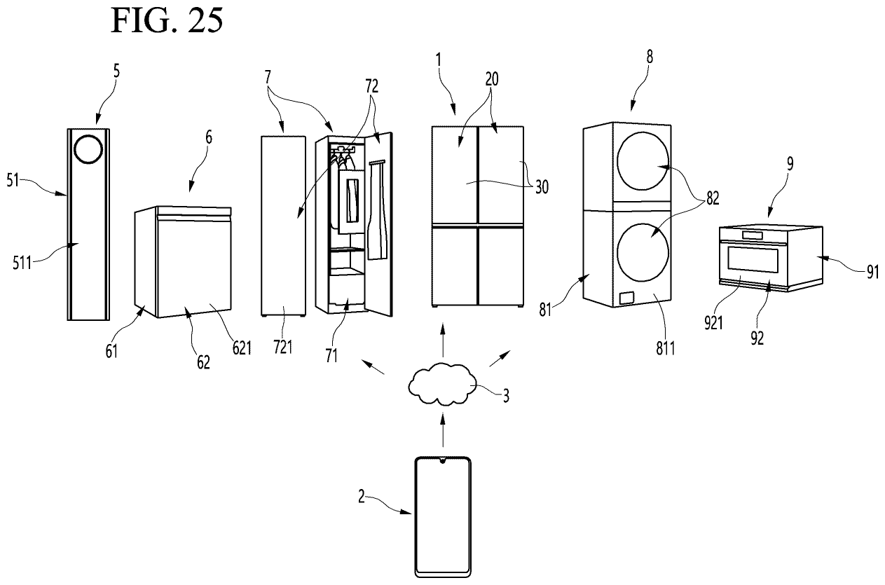

The color of the panel 31 can be determined by the operation of the lighting device 32. For example, the lighting device 32 can be manipulated and set through a remote device 2 (in FIG. 25) located away from the refrigerator 1. For example, the remote device 2 can be various devices capable of communication, such as a dedicated terminal, a mobile phone, a tablet, a portable PC, a desktop PC, a remote control, a Bluetooth speaker, or the like.

The user can manipulate and set the overall operation status of the lighting device 32, such as the operation time, operation conditions, and light source emission color of the lighting device 32, through the manipulation of the remote device 2. For example, the simple manipulation and setting of the lighting device 32 may be possible through an application or dedicated program installed on the user's mobile phone. In other words, the user can select the color of a desired panel 31 through the screen of a remote device 2, such as a mobile phone or terminal.

Additionally, the user can input a color through the manipulation part provided in the refrigerator 1 without using the remote device 2.

In addition, the refrigerator 1 and the remote device 2 can be connected to the server in a network state, and therefore, the color of the panel 31 of the refrigerator 1 can be input through the server 3 (in FIG. 25). The lighting device 32 can be turned on by the user's manipulation, and when the lighting device 32 is turned on, the front surface of the door 20 lights up in a second color selected by the user.

For example, the controller of the refrigerator 1 can control the front surface of the door 20 to glow in a second color different from the first color, and the lighting device 32 can cause the LED 322 to glow in a set color according to the control of the controller. At this time, the color of the panel 31 can be selected by the user and can be selected by the manipulation of the remote device 2.

Meanwhile, looking at the operating state of the lighting device 32, as illustrated in FIG. 11, when the lighting device 32 is turned on, the light irradiated from the LED 322 can be irradiated forward.

In other words, the light irradiated from the LED 322 passes through the hole 331 of the guide member 33 and the through-hole 311 of the panel 31 in sequence. At this time, the light passing through the hole filling member 312 may be diffused to cause the panel 31 to glow brighter.

The through-holes 311 can be disposed in a fine size throughout the panel 31, and thus, the panel 31 can appear as a set color, i.e., a second color, by light passing through the through-holes 311.

Meanwhile, when the controller instructs to change the color of light irradiated from the lighting device 32 while the outer appearance of the front surface of the refrigerator 1 is illuminated in a set color, the panel 31 illuminates in a different color reset by the controller.

In addition, among the plurality of doors 20 forming the outer appearance of the front surface of the refrigerator 1, the panels 31 forming some of the doors 20 may be illuminated, or the panels 31 forming the plurality of doors 20 may be independently illuminated in different colors to form the outer appearance of the front surface of the refrigerator 1.

In addition, as illustrated in FIG. 13, it may be possible for the lighting device 32 to operate and output a screen through the panel 31.

It may be possible to output characters, pictures, figures, images, or videos on the panel 31 through the on/off and/or colors of the LEDs 322 that are turned on, which constitute the lighting device 32. In other words, the panel assembly 30 may function as an output device that displays a type of screen that can be expressed by the lighting device, and therefore, the panel 31 may also be referred to as a screen or display.

In detail, when the LED 322 is turned on, the light of the LED 322 is irradiated into the through-hole 311. At this time, the light irradiated from the LED 322 by the hole 331 is prevented from leaking into the neighboring through-hole 311. In other words, the light is prevented from leaking out of the hole 331 by the inner surface of the hole 331, and the light of the LED 322 can only illuminate the corresponding through-hole 311.

In addition, the guide member 33 may have a material or color capable of reflecting light. For example, the guide member 33 may be formed in white, and the light irradiated from the LED 322 may be reflected and directed all toward the through-hole 311. In addition, the guide member 33 may be injection-molded using a material containing a diffusion agent.

Accordingly, the plurality of through-holes 311 can independently glow by each of the LEDs 322 and express independent colors. In other words, by using the plurality of through-holes 311 disposed on the entire front surface of the panel 31, not only can the color of the front surface of the door 20 be changed, but also various pictographs and graphic symbols can be expressed to convey information to the user. The panel 31 can also function as a display and output images and pictures.

In addition, the operation of the lighting device 32 that outputs the screen can be set by the user through a program or application built into the remote device 2. Therefore, the user can freely output desired videos, images, text, or the like on the panel 31 through the user's manipulation of the remote device 2 rather than through direct manipulation of the refrigerator 1, and there is an advantage in that information can be transmitted to the user through this.

In addition, the refrigerator 1 can be connected to a user's remote device 2 and a server via a network to communicate necessary information, and can display the information obtained through the communication on the panel 31.

Meanwhile, the present disclosure may have various other embodiments in addition to the above-described embodiments. Another embodiment of the present disclosure is characterized in that the panel assembly is provided with a lighting device and a light guide plate to irradiate light so as to pass through the through-hole. Since the other embodiment of the present disclosure is the same as the above-described embodiment except for the structure of a part of the panel, in order to prevent duplication of explanation, detailed descriptions and illustrations of the same components are omitted and the same drawing reference numerals are used to indicate them.

Hereinafter, other embodiments of the present disclosure will be described in more detail with reference to the drawings.

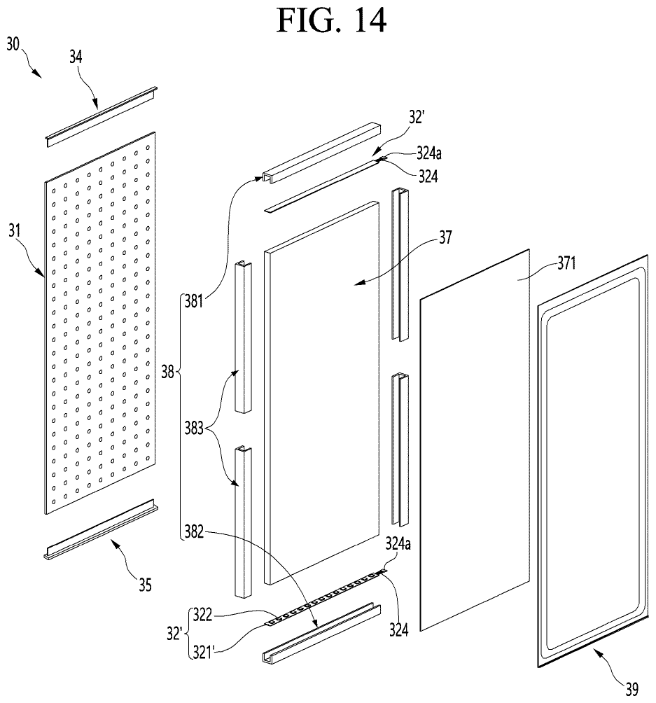

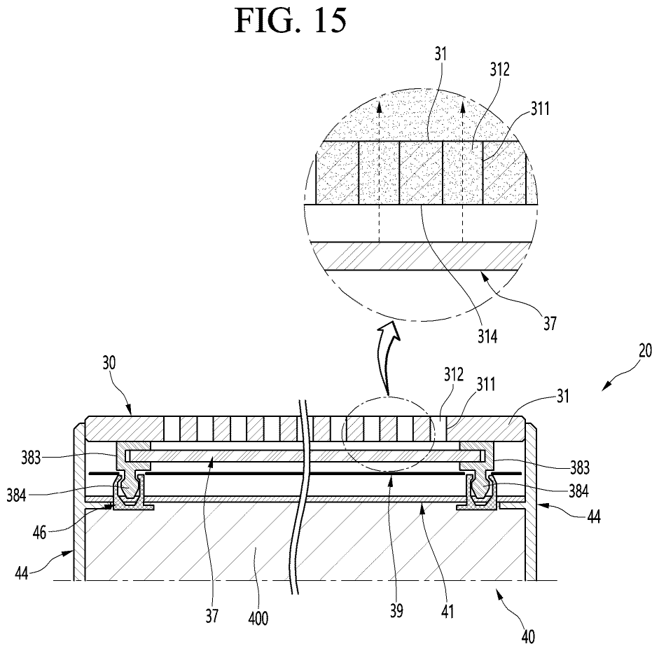

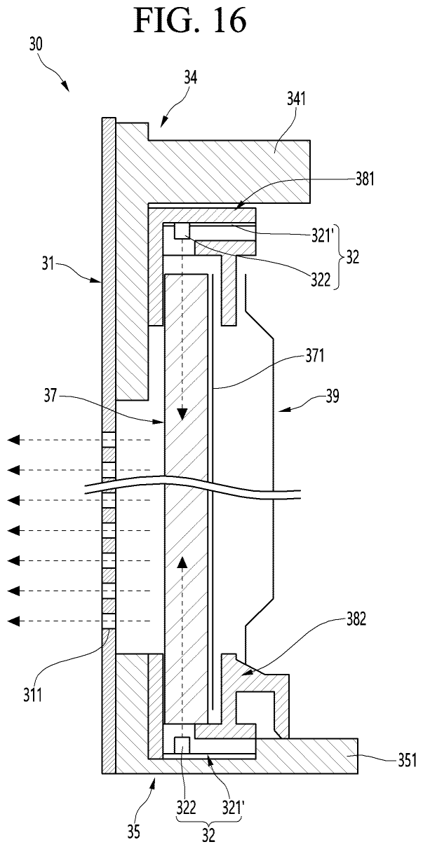

FIG. 14 is an exploded perspective view illustrating a panel assembly according to another embodiment of the present disclosure, FIG. 15 is a cross-sectional view taken along line A-A′ of FIG. 3 in another embodiment of the present disclosure, and FIG. 16 is a cross-sectional view taken along line C-C′ of FIG. 4 in another embodiment of the present disclosure.

As illustrated in the drawing, the door 20 may include a door body 40 that opens and closes the storage space as a whole, and a panel assembly 30 mounted on the front surface of the door body 40. The structure of the door body 40 is the same as in the above-described embodiment, and the panel assembly 30 may be detachably attached to the door body 40 in a state where it is assembled into one module.

The panel assembly 30 may include a panel 31 forming a front surface, a light guide plate 37 at the rear of the panel 31, and a lighting device 32′that irradiates light to the light guide plate 37. In addition, the panel assembly 30 may further include a back cover 39 forming a rear surface.

The panel 31 forms the outer appearance of the front surface of the panel assembly 30 and the door 20, and may have the same structure as the above-described embodiment. In addition, a plurality of through-holes 311 may be formed in the panel 31. The through-holes 311 may be formed in the entire front area of the panel 31. The through-holes 311 are formed finely as in the above-described embodiment, and may be formed by punching or etching. In addition, the inside of the through-holes 311 may be filled with the hole filling member 312.

An upper bracket 34 and a lower bracket 35 may be provided on the upper end and the lower end of the rear surface of the panel 31. The upper bracket 34 and the lower bracket 35 may form the upper and lower surfaces of the panel assembly 30. In addition, the upper bracket 34 and the lower bracket 35 may have a structure that is coupled and separated from the door body 40 when the panel assembly 30 is detached.

In addition, a light guide plate 37 may be provided at the rear of the panel 31. The light guide plate 37 serves to guide light irradiated from the LED 322 of the lighting device 32′toward the panel 31. The light guide plate 37 may be formed of a resin material such as acrylic or PMMA (polymethyl methacrylate), and a fine pattern may be formed so that light can be uniformly irradiated toward the panel 31.

The light guide plate 37 may be formed smaller than the size of the panel 31. The light guide plate 37 may be formed larger than the area in which the plurality of through-holes 311 are disposed. A reflective layer 371 may be further formed on the rear surface of the light guide plate 37. The reflective layer 371 may reflect light moving along the light guide plate 37 toward the panel 31, i.e., toward the front.

A holder 38 may be provided around the periphery of the light guide plate 37. The holder 38 fixes an end part of the light guide plate 37 so that the light guide plate 37 can be fixedly mounted inside the panel assembly 30. In addition, the holder 38 may be fixedly mounted on the rear surface of the panel 31.

The lighting device 32′can be mounted on the holder 38. The holder 38 can be injection-molded with a plastic material and have a structure that can be coupled with each component. For example, the holder 38 has one side open and an end part of the light guide plate 37 can be inserted to fix the light guide plate 37. In addition, the holder 38 can be configured in multiple separate pieces.

The panel 31 and the holder 38, which are different materials, may have different expansion rates due to the heat generated during the operation of the lighting device 32′. In particular, the panel 31 may be formed of a plate-shaped metal material, and may be vulnerable to thermal deformation due to its thin thickness compared to its size. In addition, the holder 38 may be formed of a plastic material, and may have a different thermal deformation rate from that of the panel 31.

In detail, when the lighting device 32′is operated, heat is generated, and the panel 31 and the holder 38 may undergo thermal expansion. In addition, the panel 31 and the holder 38 are formed of different materials and have different thermal deformation rates, and a structural difference in heat transfer may occur according to the installation position of the lighting device 32′. Due to this difference, the panel 31 and the holder 38 that are coupled to each other when the lighting device 32′is operated may have different deformation amounts, and this may cause a problem in that deformation of the panel 31 may occur. In order to prevent deformation of the panel 31, the holder 38 may have a structure in which multiple pieces are separated.

For example, the holder 38 may include an upper holder 381 extending along the upper and lower ends of the light guide plate 37, a lower holder 382, and a side holder 383 extending along the left and right sides of the light guide plate 37. The upper holder 381, the lower holder 382, and the side holder 383 may all be formed in a separate state.

In addition, at least a part of the holder 38 may be formed integrally with the upper bracket 34 and the lower bracket 35. In addition, when the light guide plate 37 has a vertically elongated structure, a plurality of holders 38 disposed at the side of the light guide plate 37 may be disposed vertically spaced apart from each other.

In other words, when the lighting device 32′is installed in the holder 38, more heat generated from the lighting device 32′is transferred to the holder 38, and the holder 38 may be deformed more than the panel 31. However, the holder 38 may be spaced apart from the neighboring holder 38 to provide a space corresponding to thermal expansion and contraction. Accordingly, even if the holder 38 is thermally deformed, the panel 31 may be prevented from being deformed.

The lighting device 32′may be disposed spaced apart from the light guide plate 37 and may be disposed to irradiate light toward an end part of the light guide plate 37. For example, the lighting device 32′may be disposed at the upper end and the lower end of the light guide plate 37. According to necessity, the lighting device 32′may be provided only at one end of the upper end and the lower end of the light guide plate 37.

Among the lighting devices 32′, the lighting device 32′provided above the light guide plate 37 can be disposed inside the holder 38. In addition, among the lighting devices 32′, the lighting device 32′provided below the light guide plate 37 can be disposed inside the lower bracket 35.

The lower bracket 35 forms the lower surface of the panel assembly 30, accommodates the lighting device 32′, and may have a structure in which the lower end of the panel assembly 30 is fixed to the panel 31.

The lighting device 32′may be arranged to extend along the end part of the light guide plate 37. For example, the lighting device 32′may be disposed along the upper end and the lower end of the light guide plate 37. The lighting device 32′may be composed of a substrate 321′and an LED 322. The lighting device 32′may be referred to as a light module.

The substrate 321′may be formed to extend along an end part of the light guide plate 37. In addition, the substrate 321′may be formed to have a length corresponding to the length of the light guide plate 37. In addition, the substrate 321′may be accommodated inside the holder 38.

A connecting line 324 and a connector 324a for electrical connection with the door body 40 may be provided on one side of the substrate 321′.

An LED 322 may be disposed on the substrate 321′. A plurality of the LEDs 322 may be disposed continuously along the substrate 321′. In addition, a plurality of the LEDs 322 may be disposed spaced apart from each other along the end part of the light guide plate 37. The LED 322 may be disposed to irradiate light toward the end part of the light guide plate 37. For example, the LED 322 may be disposed to face the upper end and the lower end of the light guide plate 37. The LED 322 may be an RGB LED that irradiates light of various colors. The LED 322 may irradiate light of various colors by a user's manipulation.

The back cover 39 forms the rear surface of the panel assembly 30 and can shield internal components of the panel assembly 30. The back cover 39 can shield the light guide plate 37 and the holder 38 from the rear. The back cover 39 can be fixed by being coupled with the upper bracket 34 and the lower bracket 35.

Meanwhile, a fixing protrusion 384 protruding rearwardly may be formed on the rear surface of the panel assembly 30. The fixing protrusion 384 may be formed integrally with the holder 38. The fixing protrusion 384 may be inserted into a holder bracket 46 exposed through the front surface of the door body 40. By coupling the fixing protrusion 384 and the holder bracket 46, the panel assembly 30 may be fixed at both left and right ends.

In addition, an upper fixing part 341 and a lower fixing part 351 may be formed protrudingly on the upper bracket 34 and the lower bracket 35, respectively. The upper fixing part 341 and the lower fixing part 351 may be respectively coupled to the upper cap decoration 43 forming the upper part of the door body 40 and the lower cap decoration 45 forming the lower part. In other words, the upper end and the lower end of the panel assembly 30 may be fixed to the door body 40 by the upper and lower fixing parts.

For example, when mounting the panel assembly 30, the upper fixing part 341 can be inserted and fixed into the upper cap decoration 43 while the lower fixing part 351 is seated to the lower cap decoration 45. In addition, the fixing protrusions (384) on both left and right sides of the panel assembly 30 can be coupled with the holder bracket 46. Accordingly, the upper, lower, left, and right ends of the panel assembly 30 can all be firmly coupled with the door body 40.

Meanwhile, when the LED 322 is turned off, the outer appearance of the front surface of the door 20 can be formed by the color and texture of the panel 31. At this time, the coating layer 313 can be formed on the front surface of the panel 31 so that the through-hole 311 cannot be seen when the lighting device 32′is turned off. In addition, the through-hole 311 can be filled with the hole filling member 312. In addition, the diffusion sheet 314 can be attached to the rear surface of the panel 31.

When the LED 322 is turned on, light is irradiated to the end part of the light guide plate 37, and the light guided by the light guide plate 37 can be irradiated forward toward the panel 31. At this time, light can be evenly irradiated to the entire surface of the panel by the light guide plate 37, and the plurality of through-holes 311 formed in the panel 31 can be evenly illuminated.

The penetration holes 311 are formed in a number of microscopic sizes, and the entire panel 31 can appear to be glowing as the entire panel is illuminated by the light guide plate 37. In addition, the panel 31 can glow in a set color according to the color of the light irradiated by the LED 322.

Accordingly, the user can form the appearance of the panel 31 in a desired color, and the panel 31 can change to a desired color of the outer appearance according to the operation of the LED 322.

In addition, the color irradiated from the LED 322 can be linked to the operation information of the refrigerator 1. For example, the LED 322 can be turned on with a set color according to the temperature of the refrigerator 1, the storage status of food, and a specific operation mode, so that the color of the outer appearance of the panel 31 can be changed. In addition, the color irradiated from the LED 322 can be determined according to information provided from the outside or settings provided to the user.

Meanwhile, although not illustrated, in the panel assembly 30 according to the embodiment of the present disclosure, various light-irradiating devices capable of irradiating light so as to pass through the through-hole 311, such as a flat light-irradiating body, a flexible display, or an electrophoretic display, may be used instead of the lighting device 32, 32′.

Meanwhile, the panel assembly according to embodiments of the present disclosure can be applied not only to refrigerators but also to various other home appliances.

Below, another embodiment is described in which an electrophoretic display (EPD) panel is attached to the outer appearance surface to change the design or color of the outer appearance based on user input or operating status. First, a refrigerator is described as a type of home appliance, and the description of the refrigerator below can be applied to other types of home appliances.

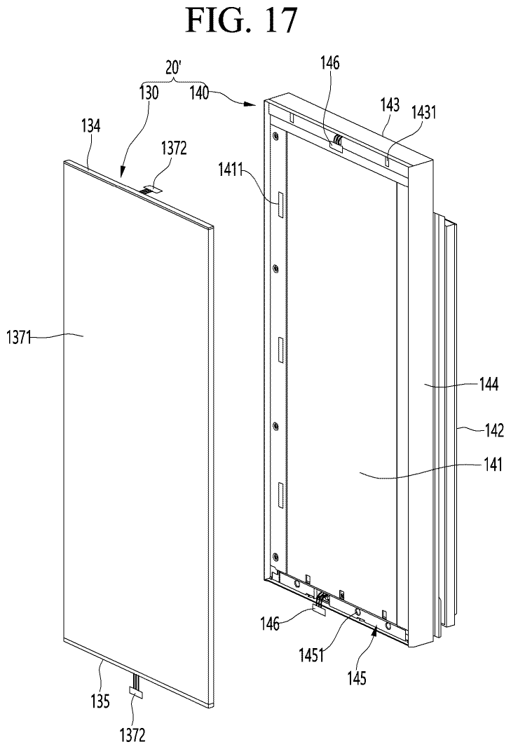

FIG. 17 is an exploded perspective view illustrating a state where the panel assembly and door body are separated.

As illustrated, the door 20′may include a door body 140 that forms the overall shape of the door 20′and opens and closes the storage space, and a panel assembly 130 that forms the outer appearance of the front surface of the door 20′.

The door body 140 may include a body plate 141 forming the front surface and a door liner 142 forming the rear surface. In addition, the door body 140 may include a side decoration 144 forming left and right sides of the door body 121. The side decoration 144 may extend in a vertical direction, and the upper end may be coupled with an upper cap decoration 143 and the lower end may be coupled with a lower cap decoration 145.

The space inside the door body 140 can be filled with insulation material 1400.

A structure for mounting the panel assembly 130 may be provided on the front surface of the door body 140.

The panel assembly 130 can be coupled to the door body 140 in a variety of ways.

For example, an upper mounting part 1431 into which an upper protrusion protruding from the rear surface of the panel assembly 130 is inserted may be formed on the front surface of the upper cap decoration 143. A lower mounting part 1451 into which a lower protrusion protruding from the rear surface of the panel assembly 130 is inserted may be formed on the front surface of the lower cap decoration 145.

The panel assembly 130 can be detachably mounted on the door body 140 in an assembled state. Since the door body 140 and the panel assembly 130 have a structure in which they can be detachably mounted, service and maintenance are easy.

The door body 140 may be provided with a door body connector 146 that is electrically connected to a power line that supplies power to the electrical components within the panel assembly 130 and a connection line that transmits a signal.

For example, the door body connector 146 may be provided at the upper end and the lower end of the door body 140, respectively. The door body connector 146 is electrically connected to the panel connector 1372. The panel assembly 130 may be provided with a lighting device 136 and an electrophoretic panel 137. The panel connector 1372 is electrically connected to the door body connector 146, and may supply power to the lighting device 136 and the electrophoretic panel 137, and may be controlled through a signal line.

The panel assembly 130 is formed in a plate shape and forms the outer appearance of the front surface of the door 20′when mounted on the front of the door body 140. The panel assembly 130 may also be referred to as a door panel or an outer appearance panel.

The panel assembly 130 can display various designs or colors based on user input or the operating status of the refrigerator, including an electrophoretic panel 137.

In addition, the panel assembly 130 includes a lighting device 136 that irradiates light so that the front of the panel assembly 130 can glow brightly. The lighting device 136 complements the electrophoretic panel 137 so that the panel assembly 130 can have brighter brightness and express vivid colors.

This allows the user to change the outer appearance of the refrigerator to a desired design or color without physically replacing the panel assembly 130. In addition, a user-selected picture, text, image, video, pictogram, or the like can be displayed on the refrigerator door.

In addition, by changing the design or color of the outer appearance based on the operating status of the refrigerator, the operating status can be conveyed more intuitively to the user.

Below, a panel assembly according to one embodiment of the present disclosure is described in detail.

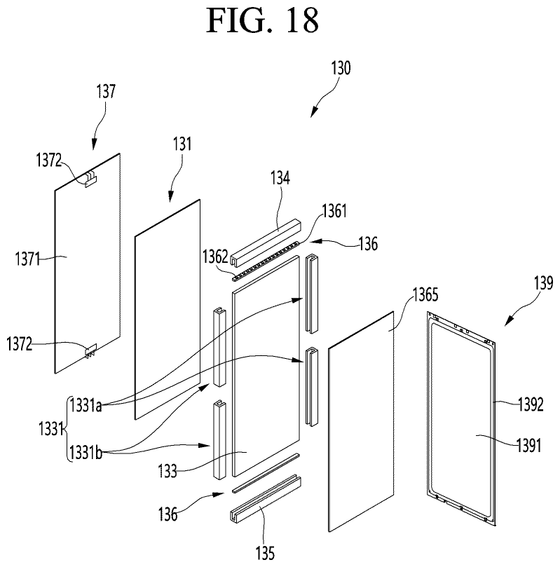

FIG. 18 is an exploded perspective view illustrating a panel assembly according to another embodiment.

A panel assembly of one embodiment includes an electrophoretic panel 137, a transparent panel 131, and a lighting device 136.

The electrophoretic panel 137 may include a panel main body 1371 and a panel connector 1372 connecting the panel main body 1371 and the controller 138.

The panel main body 1371 includes, for example, an activation film (front plane laminate, FPL) in which ink capsules are provided.

The panel main body 1371 may include an upper electrode layer provided on upper end of the activation film and a lower electrode layer provided under the activation film. Each of the upper electrode layer and the lower electrode layer may be electrically connected to a panel connector 1372.

A control command can be received from the controller 138 through the panel connector 1372, and a charge can be applied to the ink capsules of the activation film based on the control command. For this purpose, the upper electrode layer and the lower electrode layer can include a TFT (thin film transistor). The activation film uses small ink capsules containing color particles as pixels, and can express an image by changing the arrangement of the internal color particles of each ink capsule based on the charge transferred from the electrode layer.

At this time, the color particles of the activation film can be prepared as colored particles, allowing the activation film to display various colors.

Additionally, according to the embodiment, the activation film may be composed of a black absorption element and may further include a color filter to form pixels.

In this way, the design or color of the outer appearance of the refrigerator can be easily changed by providing an electrophoretic panel 137. In addition, the electrophoretic panel 137 operates at low power and uses electricity only when the content of the pixel changes, so no electricity is needed when a still image is continuously displayed. Accordingly, the energy efficiency of the refrigerator can be maintained at a high level.

In addition, the electric field display has flexibility, so it can be applied to a refrigerator 1 configured as a curve, and there is no limitation on the viewing angle, so high visibility can be secured.

However, according to the embodiment, the door panel may be provided with a different type of display panel (e.g., ClearInk, electrowetting display (EWD), Memory LCD, interferometric modulator display (IMOD), LCD panel) rather than an electrophoretic display panel.

A transparent panel 131 may be provided at the rear of the electrophoretic panel 137. The transparent panel 131 may be formed in a plate shape and may be formed of a transparent material that allows light to pass through.

For example, the transparent panel 131 may be formed of a glass material such as blue glass, white glass, or deposited glass, or another material that allows light transmission such as ABS, PMMA, or PC.

In addition, the transparent panel 131 can be formed so that the transparent panel 131 itself has a unique color. Accordingly, when the electrophoretic panel 137 and the lighting device 136 are turned off, the outer appearance of the refrigerator can be formed with the unique color of the transparent panel 131.

The transparent panel 131 can be processed to increase the diffusion of light irradiated from the lighting device 136.

For example, the transparent panel 131 includes an additive such as a diffusion agent to diffuse light, so that the front surface of the door 20′can be illuminated evenly.

A fine pattern may be formed on the surface of the transparent panel 131. The pattern is formed in a rough shape on the transparent panel 131, and can further expand the dispersion of light irradiated from the surface of the transparent panel 131.

A lighting assembly may be provided at the rear of the transparent panel 131. The lighting assembly is configured to irradiate light toward the electrophoretic panel 137.

For example, the lighting assembly includes a lighting device 136 equipped with a light source and a light guide plate 133 that guides light irradiated from the lighting device 136.

The lighting device 136 is configured to irradiate light to determine the color and brightness of the front surface the panel assembly 130 and irradiate light toward the light guide plate 133.

The lighting device 136 may be provided above or below the light guide plate. In addition, a plurality of lighting devices 136 may be provided above and below the light guide plate, respectively.

The first lighting device 136a may be provided inside the upper bracket 134.

The upper bracket 134 has a structure in which one side is open so that a light guide plate 133 can be inserted, and a first lighting device 136 is mounted inside.

The first lighting device 136a may be provided on the upper part of the light guide plate 133 while being mounted on the upper bracket 134. In addition, the upper end of the light guide plate 133 may be inserted into and fixed to the upper bracket 134.

The front surface of the upper bracket 134 can be fixed to the transparent panel 131 using an adhesive or the like.

The lower bracket 135 has a structure in which one side is open so that a light guide plate 133 can be inserted, and a second lighting device 136 is mounted inside.

The second lighting device 136 may be provided inside the lower bracket 135, and may be provided at the lower part of the light guide plate 133 while mounted on the lower bracket 135. The lower end of the light guide plate 133 may be inserted into and fixed to the upper bracket 134.

The front surface of the lower bracket 135 can be fixed to the transparent panel 131 using an adhesive or the like.

The light guide plate 133 may be positioned at the rear of the transparent panel 131. The light guide plate 133 may be configured to guide light irradiated from the lighting device 136 forward.

Meanwhile, side brackets 1331 may be provided on both sides of the light guide plate 133 so that both ends of the light guide plate 133 can be inserted. One side of the side bracket 1331 is open so that a part of the light guide plate 133 can be inserted.

The side bracket 1331 may be extended along both sides of the light guide plate 133. The side bracket 1331 may be composed of a first side bracket 1331a provided on one side of the light guide plate 133 and a second side bracket 1331b provided on the other side of the light guide plate 133.

A plurality of first side brackets 1331a may be provided at the upper end part and the lower end part on one side of the light guide plate 133. In other words, a plurality of first side brackets 1331a may be disposed spaced apart from each other in the vertical direction.

A plurality of second side brackets 1331b may be provided at the upper and lower ends of one side of the light guide plate 133. In other words, a plurality of second side brackets 1331b may be disposed spaced apart from each other in the vertical direction.

The front surface of the side bracket 1331 can be fixed to the transparent panel 131 using an adhesive or the like.

In this way, the upper bracket 134, lower bracket 135, and side bracket 1331 have a structure that allows a part of the light guide plate to be inserted, thereby fixing the light guide plate.

In addition, the upper bracket 134, the lower bracket 135, and the side bracket 1331 can be fixed to the transparent panel 131. In a state where the upper bracket 134, the lower bracket 135, and the side bracket 1331 are fixed to the transparent panel 131, the light guide plate 133 can be disposed to be spaced apart from the transparent panel 131 by a set gap.

These brackets 134, 135, 1331 can be formed from a plastic injection molded product.

The lighting device 136 may be provided with a substrate and a plurality of light sources arranged in a row on the substrate. The LED 1362 may be composed of an R.G.B LED.

The brightness of the panel assembly 130 can be adjusted through the lighting device 136. For example, the electrophoretic panel 137 can change the outer appearance thereof to a color set to low power, or output images, shapes, texts, or the like set by the user, but it is not easy to adjust the brightness of the electrophoretic panel 137 itself. In other words, the electrophoretic panel 137 alone can express relatively low chroma, but cannot express brightness.

The lighting device 136 can be operated as needed at the rear of the electrophoretic panel 137 to adjust the overall brightness of the panel assembly 130 to be brighter. In addition, it has the advantage of making the color to be implemented on the front surface of the panel assembly 130 clearer and enabling implementation of various colors.

In addition, color expression may be possible with only the lighting device 136 while the electrophoretic panel 137 is turned off. Of course, by operating the electrophoretic panel 137 and the lighting device 136 together, expression close to the color and brightness set by the user is possible.

A reflector 1365 may be further provided at the rear of the lighting assembly 1360. The reflector 1365 may reflect light irradiated from the LED 1362 to improve the efficiency of the lighting device 136.

The panel assembly 130 may include a back cover 139 forming the outer appearance of the front surface. The back cover 139 may be formed in a plate shape. The back cover 139 may support the rear surface of the lighting assembly 1360. The back cover 139 may be formed in a plate shape of a metal material. The back cover 139 may include a central cover protrusion 1391 and a cover perimeter part 1392.

In another embodiment, the panel assembly may be formed with a curve.

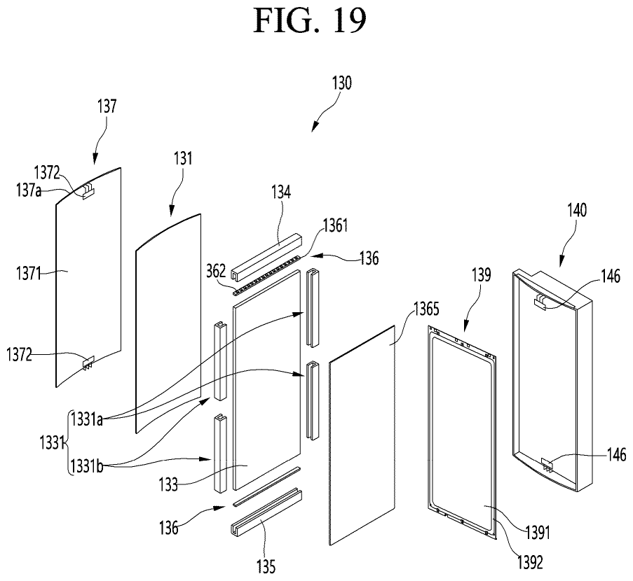

FIG. 19 is an exploded perspective view illustrating a panel assembly according to another embodiment.

As illustrated in FIG. 19, the electrophoretic panel 137 is flexible and can be configured as a curve 137a. In this case, there is no limitation on the viewing angle, so high visibility can be secured.

For example, the electrophoretic panel 137 can be formed in a shape that becomes rounder towards the rear from the center to both sides.

The transparent panel 131 can also be formed in a round shape corresponding to the shape of the electrophoretic panel 137.

At this time, if the transparent panel 131 is made of glass, the bend can be formed by applying pressure with a jig (1 Jig) after heat treatment. In addition, if the transparent panel 131 is made of a plastic material, the bend can be formed by a method of forming a curve in an injection-molded product using a known technology.

A mounting part 1311 that can be fixed to a lighting assembly 1360 may be provided on the rear surface of the transparent panel 131. The mounting part 1311 may be formed at each of the upper end part and the lower end part of the transparent panel 131. The mounting part 1311 may be composed of an adhesive or the like.

The mounting part 1311 is formed with different thicknesses at the center and one side of the transparent panel 131, so that the lighting assembly 1360 and the transparent panel 131 can be firmly fixed.

The reflector 1365 and back cover 139 described above may be provided on the rear of the transparent panel 131.

Meanwhile, the lighting assembly 1360 can be configured in various ways.

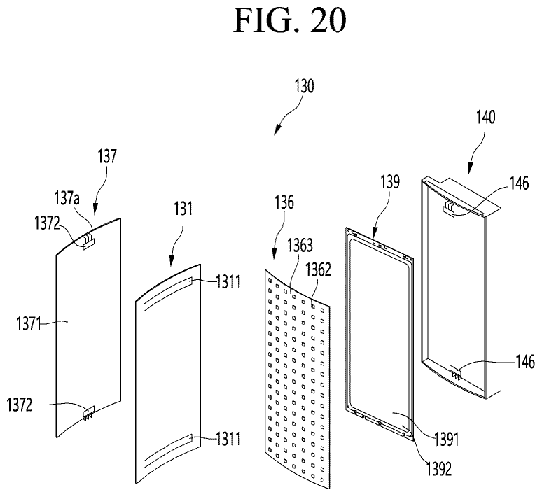

FIG. 20 is an exploded perspective view illustrating a panel assembly according to another embodiment.

The lighting device 136 may include, for example, a plate-shaped substrate 1361 and a plurality of LEDs 1362 disposed on the front surface of the substrate 1361.

At this time, the substrate 1361 can be configured in various shapes in which the LED 1362 can be mounted and supported.

For example, the substrate 1361 may be formed to a size corresponding to the transparent panel 131 or the electrophoretic panel 137. Of course, the substrate 1361 may be divided into a plurality of pieces, and the substrates may be assembled to form the entire lighting device 136.

On the substrate 1361, a plurality of LEDs 1362 can be disposed at regular gaps to form one surface so as to illuminate the entire area of the transparent panel 131.

These LEDs 1362 may be composed of RGB LEDs (Red Green Blue light irradiating diodes).

As another example, the lighting device 136 may be composed of a base 1363 in the form of a film and a plurality of LEDs 1362 mounted on the base 1363.

The base 1363 may be formed of one sheet or a plurality of sheets and may be configured in a film-like shape. This lighting device 136 is flexible and can be mounted in a curved state.

The base 1363 may include a first layer formed of a PT material and a second layer formed of a silicon material. An electrode connected to an LED 1362 may be disposed between the first layer and the second layer. The second layer is configured to shield the LED 1362. The base 1363 may be formed of a transparent material that allows light irradiated from the LED 1362 to pass through.

Since each of a plurality of LEDs 1362 is configured to be turned on/off independently, characters, images, emoticons, or the like can be expressed by controlling the LEDs 1362.

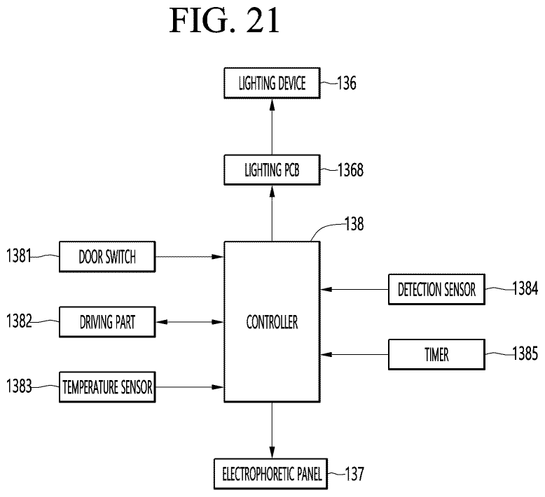

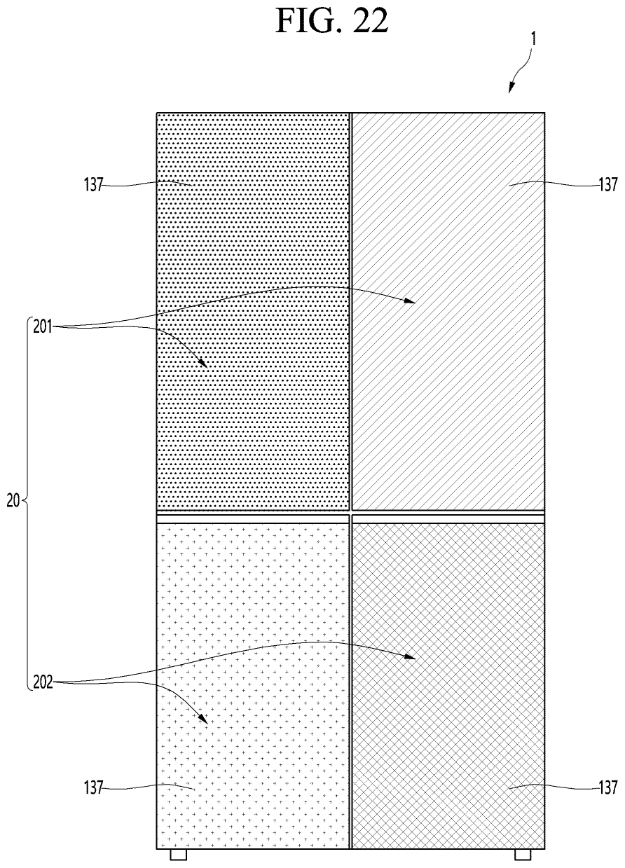

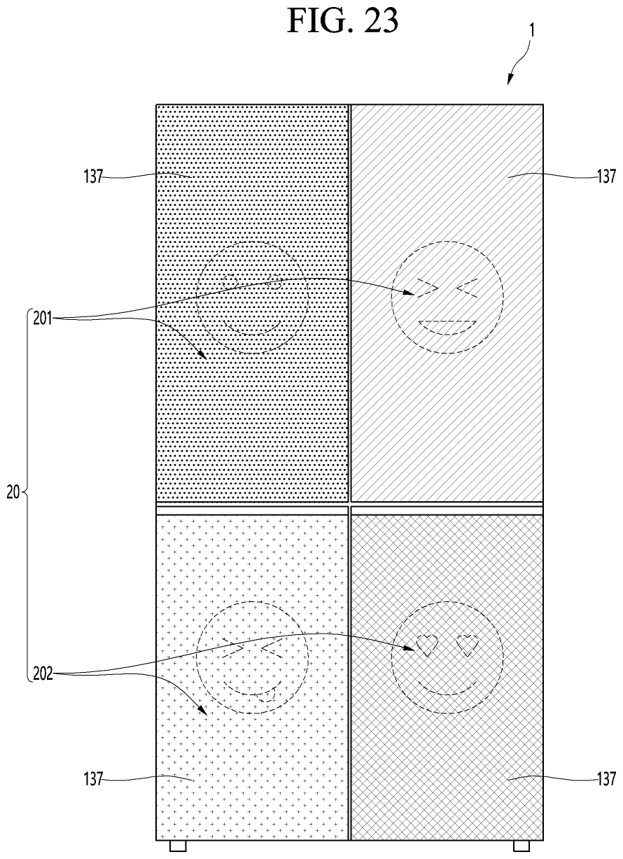

FIG. 21 is a block diagram illustrating the flow of control signals of a refrigerator, FIG. 22 is a front view illustrating a state where the front color of the door has changed, and FIG. 23 is a front view illustrating a state where the emoticon set on the front surface of the door is output.

The user can set up the electrophoretic panel 137 and lighting device 136 respectively through a remote device 2. The remote device 2 can be a variety of devices capable of communication, such as a dedicated terminal, a mobile phone, a tablet, a portable PC, a desktop PC, a remote control, and a Bluetooth speaker.

The user can manipulate and set the overall operating status of the electrophoretic panel 137, such as the operating time, operating conditions, and the light-irradiating color of the light source, through the manipulation part provided in the remote device 2 or refrigerator 1.

Additionally, the user can manipulate and set the overall operating status of the lighting device 136 through a remote device 2 or a manipulation part.

The refrigerator 1 and the remote device 2 can be connected to the server in a network state. Accordingly, the color or image of the refrigerator 1 door 20′can be input through the server.

The controller 138 can control the electrophoretic panel 137 and the lighting device 136 to be output in a state set by the user.

The panels 131 forming some of the doors 20′among the plurality of doors 20′forming the outer appearance of the front surface of the refrigerator 1 may be illuminated, or the panels 131 forming the plurality of doors 20′may be independently illuminated in different colors to form the outer appearance of the front surface of the refrigerator 1.

Additionally, the lighting device 136 or the electrophoretic panel 137 can be turned on at a specified time or set time gap input from the timer 1385 to change the color of the front surface of the door 20′.

The electrophoretic panel 137 and lighting device 136 may be operated according to the operating status of the refrigerator 1.

According to the operation mode or status of the refrigerator 1, the electrophoretic panel 137 and lighting device 136 can be operated in a preset state to change the color of the front surface of the door 20′.

For example, if the door 20′is open for a long time and no signal is input from the door switch 1381 for a set time or longer, the electrophoretic panel 137 can operate to notify that the door 20′is open, causing the front surface of the door 20′to glow in a different color.

The electrophoretic panel 137 and the lighting device 136 may be operated according to the operation of the driving part 1382 for the operation of the refrigerator 1. For example, the driving part 1382 may be a compressor. In detail, if the controller 138 determines that the compressor is operating abnormally or is malfunctioning, the lighting device 136 may be operated accordingly. In other words, when the compressor is determined to be abnormal, the front surface of the door 20′may be made to glow in a set color, or the compressor may be turned on and off repeatedly to inform the user of the abnormality.

The driving part 1382 can be configured in various ways, such as a defrost heater, a deodorizing device, an ice maker, a water purifier, or the like, and the lighting device 136 or the electrophoretic panel 137 can be operated in connection with the operation of these driving parts 1382.

As another example, according to the amount of ice produced by the ice maker, the lighting device 136 or the electrophoretic panel 137 may be operated to indicate the status of the ice maker or the amount of ice produced through the color of the door 20′.

In addition, it may be operated according to the temperature inside the refrigerator detected by the lighting device 136 or the electrophoretic panel 137 and the temperature sensor 1383. For example, the electrophoretic panel 137 and the lighting device 136 may cause the front surface of the door 20′to glow in a set color according to a set temperature range, thereby allowing the temperature status to be intuitively known.

In addition, the lighting device 136 may be operated according to the detection sensor 1384. For example, the detection sensor 1384 may be a proximity sensor. In detail, when the proximity sensor detects the proximity of a user, the output of the lighting device 136 may be lowered to prevent glare to the user, thereby making the brightness of the door 20′darker.

The electrophoretic panel 137 or lighting device 136 can shorten the change cycle of the door color or initiate the change when the proximity of a user is detected by the detection sensor, and can perform a set operation when the user approaches, such as causing the color to change continuously.

As another example, the detection sensor 1384 may be an illumination sensor. The brightness of the door 20′may be adjusted by controlling the operation of the lighting device 136 according to the illumination detected by the illumination sensor.

The electrophoretic panel 137 and lighting device 136 may be operated according to the status of not only the refrigerator but also other devices that are networked or can communicate with the refrigerator 1.

For example, when the washing machine or dryer's laundry is completed, the door may glow in a color set by the operation of the lighting device 136 to inform the user of the status of the washing machine or dryer.

Meanwhile, as illustrated in FIG. 22, the controller 138 can control the electrophoretic panel 137 and the lighting device 136 to cause each of the plurality of doors to glow in different colors.

Meanwhile, as illustrated in FIG. 23, the panel assembly 130 can output characters, pictures, figures, images, videos, pictograms, or the like. The panel assembly 130 can function as an output device that displays a type of screen that can be expressed through an electrophoretic panel 137 and a lighting device 136.

For example, when a user selects characters, pictures, images, or the like. to be output on the door 20′from a remote device 2 or an input part, the controller 138 can receive the information selected by the user. Then, the controller 138 can control the lighting device 136 and the electrophoretic panel 137 based on the received information.

In addition, the operation of the electrophoretic panel 137 or lighting device 136 that outputs the screen can be set by the user through a program or application built into the remote device 2. Therefore, the user can freely output desired videos, images, text, or the like on the panel 131 by manipulating the remote device 2 rather than directly manipulating the refrigerator 1, and there is an advantage in that information can be transmitted to the user through this.

Meanwhile, users can update new features of the refrigerator through remote devices. The refrigerator can add new features through updates with the server.

The new feature can be used to control the lighting device to display various color expressions on the front surface of the panel, express seasonality, and create new display themes according to refrigerator operation.

Users can use it by adding new functions by updating through a remote device. Users can output a screen on the front surface of the panel through a remote device, for example, clouds and the sky can be output on the first door, and an image or video related to the first door can be displayed on the second door. In addition, users can freely set the screen displayed on each door in the way they want.

Meanwhile, the panel assembly according to embodiments of the present disclosure can be applied not only to refrigerators but also to various other home appliances.

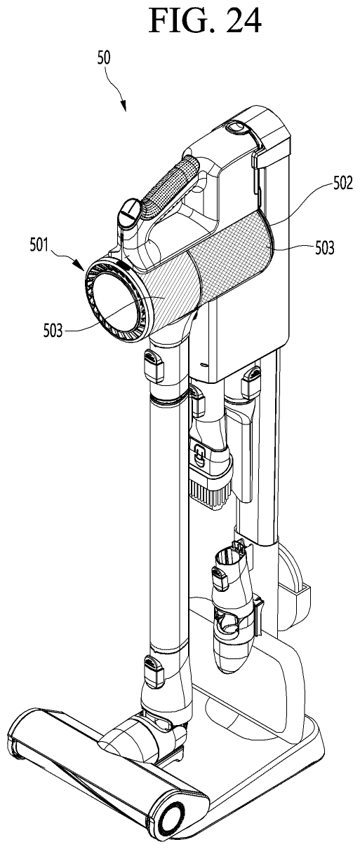

FIG. 24 is a perspective view illustrating a vacuum cleaner according to one embodiment.

A vacuum cleaner 50 according to one embodiment includes a suction motor that suctions up dust and a main body 501 that forms an outer appearance.

The main body 501 includes a dust collection bin 502 that collects the suctioned dust, and a panel assembly 503 can be disposed on the outer surface of the dust collection bin 502.

The panel assembly 503 includes a flexible electrophoretic panel 137. In addition, the panel assembly 503 may include a flexible film-shaped lighting device 136. Through this, the panel assembly 503 may also be provided in a curved shape along the outer surface of the dust collection bin 502.

The panel assembly 130 is located on the outer surface of the main body 501 and can change the design or color of the outer appearance of the vacuum cleaner.

In addition, the operating status of the vacuum cleaner can be expressed through the panel assembly 503. For example, when the vacuum cleaner is operating, the panel assembly 503 can glow in a first color. In addition, when the vacuum cleaner is charging, the panel assembly 503 can glow in a second color different from the first color.

Meanwhile, the vacuum cleaner may include a dust collection bin sensor installed in the dust collection bin 502 to detect dust chroma.

Additionally, the controller 138 can control the electrophoretic panel 137 to change color based on the dust chroma level of the dust collection bin 502 of the vacuum cleaner.

For example, as the dust chroma level of the dust collection bin increases, the panel assembly 130 can be controlled to display a darker color.

FIG. 25 is a drawing illustrating an example of controlling the color of home appliances to which the panel assembly is applied using a remote device.

As illustrated in the drawing, the home appliance according to the embodiment of the present disclosure can have its outer appearance formed by the panel assembly 30, and its outer appearance can be changed to a color set by the user according to the operation of the lighting device 32, 32′. The panel assembly 30 can have its outer appearance expressed in various colors by the light of the lighting device 32, 32′ irradiated from the rear of the panel 31, and can also output pictures, letters, images, and videos on the screen.

The home appliance may be any one of a refrigerator 1, an air conditioner 5, a dishwasher 6, a clothes manager 7, a washing machine 8, or a cooking appliance 9, each of which may have a structure similar to the panel assembly 30, 30a, 30b, 30c of the embodiments of the present disclosure so that the color of the outer appearance of the front surface may be freely changed.

For example, in the above-described embodiments and in the refrigerator 1, the panel assembly 30 may be provided on the front surface of the door 20 that opens and closes the cabinet 10. Then, the panel assembly 30 may be illuminated in a set color by a user setting, and the color of the outer appearance of the front surface of the refrigerator 1 may be changed.

As another example, the indoor part of the air conditioner 5 may have a space formed inside a case 51 (or cabinet) forming an outer appearance, in which a heat exchange device, a fan, or the like are provided. In addition, the front surface of the case 51 may be formed by a panel assembly 511. The panel assembly 511 may be configured with the same structure as the panel assembly 30 of the refrigerator 1 described above and may be illuminated.

Accordingly, the panel assembly 511 can be illuminated in a set color by user settings, and the color of the outer appearance of the front surface of the indoor part of the air conditioner 5 can be changed to the set color.

As another example, the dishwasher 6 may have a space for dishwashing formed inside a case 61 (or cabinet) forming an outer appearance. In addition, the front surface of the case 61 may be opened and closed by a door 62, and the front surface of the door 62 may be formed by a panel assembly 621. The panel assembly 621 may be configured with the same structure as the panel assembly 30 of the refrigerator 1 described above and may be illuminated.

Accordingly, the panel assembly 621 can be illuminated in a set color by user settings, and the color of the outer appearance of the front surface of the dishwasher 6 can be changed to the set color.

As another example, the clothing manager 7 may have a space formed inside a case 71 (or cabinet) forming an outer appearance, in which clothing is stored. In addition, the front surface of the case 71 may be opened and closed by a door 72, and the front surface of the door 72 may be formed by a panel assembly 721. The panel assembly 721 may be configured with the same structure as the panel assembly 30 of the refrigerator 1 described above, and may be illuminated.

Accordingly, the panel assembly 721 can be made to glow in a set color by user settings, and the color of the outer appearance of the front surface of the clothing manager 7 can be changed to the set color.

As another example, the washing machine 8 or dryer may have a space for washing or drying formed inside a case 81 (or cabinet) forming an outer appearance. In addition, the front surface of the case 81 may be opened and closed by a door 82. Meanwhile, the front surface of the case 81 may be formed by a panel assembly 811. The panel assembly 811 may be configured with the same structure as the panel assembly 30 of the refrigerator 1 described above and may be illuminated.

Accordingly, the panel assembly 30 can glow in a set color by user settings, and the color of the outer appearance of the front surface of the washing machine 8 or dryer can be changed to the set color.

As another example, the cooking appliance 9 may have a space for cooking food formed inside a case 91 (or cabinet) forming an outer appearance. In addition, the front surface of the case 91 may be opened and closed by a door 92, and the front surface of the door 92 may be formed by a panel assembly 921. The panel assembly 921 may be configured with the same structure as the panel assembly 30 of the refrigerator 1 described above and may be illuminated.

Accordingly, the panel assembly 921 can be made to glow in a set color by user settings, and the color of the outer appearance of the front surface of the cooking appliance 9 can be changed to the set color.

According to one embodiment, a home appliance includes a cabinet forming a storage space; a door body for opening and closing the cabinet; and a panel assembly mounted on the front surface of the door body, and the panel assembly includes an electrophoretic panel and a lighting device.

In one embodiment, a home appliance includes: a cabinet forming a storage space; and a door opening and closing the cabinet; in which the door includes: a door body; and a panel assembly mounted on the door body to form a front surface of the door, and the panel assembly includes: an electrophoretic panel; and a lighting assembly provided at a rear of the electrophoretic panel and irradiating light toward the electrophoretic panel.

The electrophoretic panel may include a panel main body forming the front surface of the door, and a panel connector connecting the panel main body and a controller.

The door body may be formed with an opening at the front, and a door body connector electrically connected to the panel connector is provided in the opening.

The panel main body may include a round surface.

The lighting assembly may include a substrate, a lighting device having a plurality of light sources arranged on the substrate, and a light guide plate that guides light irradiated from the lighting device.

The lighting device can be provided above or below the light guide plate.

The panel assembly may further include a bracket having one side opened to provide a space for accommodating the lighting device.

The lighting assembly may include side brackets into which both ends of the light guide plate are inserted.

It is possible to provide a transparent panel that allows light to pass through between the electrophoretic panel and the lighting assembly.

The lighting assembly may further include a reflector provided behind the light guide plate to reflect light irradiated from the light source.

The lighting assembly may include a base formed in a size corresponding to the electrophoretic panel and composed of at least one film layer; and a plurality of light sources disposed on the base and irradiating light toward the electrophoretic panel.

The base may include a round surface.

The panel assembly includes a back cover forming a rear surface of the panel assembly, and the back cover may cover the opened front surface of the door body.

The electrophoretic panel may output user-set characters and pictograms on the front surface of the door.

The lighting assembly is capable of controlling at least one of the color, brightness, and chroma of the front surface of the door when the electric motor panel is turned on.

According to an embodiment of the present disclosure, a refrigerator includes: a cabinet forming a storage space; a door body for opening and closing the cabinet; and a panel assembly mounted on the door body, wherein the panel assembly includes: a panel formed of a metal material and forming a front surface of the door, a panel having a plurality of microscopic penetration holes formed therein; and a lighting device provided on the rear surface of the panel for irradiating light; in which the plurality of penetration holes are disposed at regular gaps on the panel, and light radiated from the lighting device may transmit through the penetration holes to change the color of the panel.

The lighting device can be disposed parallel to the front of the panel and can irradiate light toward the panel.

The lighting device can irradiate light of a color set by the user.

The lighting device includes a plate-shaped substrate disposed at the rear of the panel; and a plurality of LEDs provided on a front surface of the substrate and disposed so as to face the rear surface of the panel, in which the LEDs may be provided in a number corresponding to positions corresponding to the through-holes.

A guide member is formed between the panel and the lighting device, and the front surface of the guide member is in contact with the rear surface of the panel, and the rear surface of the guide member is in contact with the front surface of the substrate, so that a gap between the panel and the lighting device can be maintained.

A hole for accommodating the LED is formed through the guide member, and the through-hole, hole, and LED can be disposed on a same extension line.

The guide member can be formed by adding a diffusion agent thereto.

A fixing member is provided on the rear surface of the panel, and a substrate fixing protrusion protruding backward is formed on the fixing member, and a substrate hole through which the substrate fixing protrusion penetrates is formed on the substrate, so that the substrate can be restrained.

The fixed members can be disposed at the four corners of the substrate.

The panel assembly further includes a light guide plate provided at the rear of the panel and guiding light toward the panel, and the lighting device can be disposed to irradiate light toward an end part of the light guide plate.

The lighting device can be disposed spaced apart from at least one side of the perimeter surface of the light guide plate.

The lighting device may include a substrate extending along an end part of the light guide plate; and LEDs disposed at regular gaps along the substrate and facing the end part of the light guide plate.

The panel assembly includes a holder that is disposed along the perimeter of the light guide plate and accommodates an end part of the light guide plate to secure the light guide plate, and the lighting device can be accommodated inside the holder.

The holder is formed of a different material having a different thermal expansion coefficient from that of the light guide plate, and a plurality of the holders may be spaced apart from each other.

The holder is formed with a fixing protrusion extending rearwardly so as to pass through a rear surface of the panel assembly, and the fixing protrusion can be engaged with a holder bracket provided on the door body when the panel assembly is mounted on the door body.

The panel assembly may include a back cover forming a rear surface of the panel assembly and shielding an internal configuration of the panel assembly.

A plurality of said through-holes can be formed at regular gaps across the entire front surface of said panel.

A colored layer may be formed on the front surface of the panel to render the penetration hole invisible when the lighting device is turned off.

A diffusion sheet is attached to the rear surface of the panel, and the diffusion sheet can be formed to shield all of the plurality of through-holes.

The interior of the through-holes can be filled with a hole-filling member that allows light to pass through.

### INDUSTRIAL APPLICABILITY

According to an embodiment of the present disclosure, the color of the outer appearance of the panel can be changed by light irradiated from a lighting device at the rear of the panel while the panel is mounted. Therefore, there is an advantage in that the outer appearance of the door can be changed to a color desired by the user even while the panel is mounted, and thus, the industrial applicability thereof is recognized.

In addition, the panel may be formed of an opaque material such as metal, and the color of the outer appearance of the panel made of the opaque material may be changed by allowing light to pass through microscopic through-holes formed in the panel. In particular, when the panel is formed of a metal material, the texture unique to metal may be maintained when the lighting device is turned off, and the color of the outer appearance of the panel may be changed when the lighting device is turned on, and thus, the industrial applicability thereof is recognized.

In addition, the penetration holes are formed in a microscopic size, and a coating layer is formed on the front surface of the panel so that the penetration holes are not visible when the lighting device is turned off, thereby maintaining the outer appearance of a metallic texture, and thus, the industrial applicability thereof is recognized.

In addition, by controlling the on/off or color change of the LED corresponding to the through-hole, videos, images, text, or the like can be output through the numerous minute through-holes formed on the front surface of the panel. Therefore, since the entire front surface of the refrigerator door can function as a display, and thus, the industrial applicability thereof is recognized.

In addition, the lighting device can be fixed in a mounting position by a fixing member inside the door, and the through-hole, the hole of the guide member, and the LED may be aligned to ensure light irradiation through each through-hole, and outer appearance defects can be prevented, and thus, the industrial applicability thereof is recognized.

According to a refrigerator according to an embodiment of the present disclosure, the outer appearance design can be changed without replacing the outer appearance panel by changing the outer appearance design using an electrophoretic display (EPD) panel. Accordingly, since various colors and patterns can be displayed on the outer appearance of the refrigerator with low power, the industrial applicability thereof is recognized.

According to a refrigerator according to an embodiment of the present disclosure, the outer appearance design can be improved by supplementing the color and brightness of the front surface of the door using a lighting device. Therefore, since it is possible to adjust the brightness of the outer appearance of the front surface of the door and at the same time adjust the chroma and brightness, the industrial applicability thereof is recognized.

1. A refrigerator comprising:
a cabinet forming a storage space; and
a door opening and closing the cabinet;
wherein the door includes:
a door body; and
a panel assembly mounted on the door body to form a front surface of the door, and
wherein the panel assembly includes:
a panel forming the front surface of the door; and
a lighting assembly provided at a rear of the panel and irradiating light toward the panel.

2. The refrigerator of claim 1,
wherein the panel is an electrophoretic panel, and
wherein the panel includes:
a panel main body forming the front surface of the door, and
a panel connector connecting the panel main body and a controller.

3. The refrigerator of claim 2,
wherein the door body is formed with an opening at the front, and
a door body connector electrically connected to the panel connector is provided in the opening.

4. The refrigerator of claim 3,
wherein the panel assembly includes a back cover forming a rear surface of the panel assembly, and
wherein the back cover covers the opened front surface of the door body.

5. The refrigerator of claim 2,
wherein a transparent panel that allows light to pass through is provided between the panel and the lighting assembly.

6. The refrigerator of claim 2,
wherein the lighting assembly includes:
a base formed in a size corresponding to the electrophoretic panel and composed of at least one film layer; and
a plurality of light sources disposed on the base and irradiating light toward the electrophoretic panel; and
wherein the lighting assembly adjusts at least one of the color, brightness, and chroma of the front surface of the door when the electrophoretic panel is turned on.

7. The refrigerator of claim 1,
wherein the panel is made of a metal material and includes a plurality of through-holes disposed spaced apart from each other, and
wherein the light irradiated from the lighting assembly passes through the through-holes.

8. The refrigerator of claim 7,
wherein the lighting assembly includes:
a plate-shaped substrate disposed at a rear of the panel; and
a plurality of LEDs provided on a front surface of the substrate and disposed toward a rear surface of the panel, and
wherein the LEDs are provided in a number corresponding to positions corresponding to the through-holes.

9. The refrigerator of claim 8,
wherein a guide member is formed between the panel and the lighting assembly, and
wherein a front surface of the guide member is in contact with the rear surface of the panel, and a rear surface of the guide member is in contact with the front surface of the substrate, thereby maintaining a gap between the panel and the lighting assembly.

10. The refrigerator of claim 9,
wherein the guide member is provided with a hole formed through which the LED is accommodated, and
wherein the through-hole, the hole, and the LED are disposed on a same extension line.

11. The refrigerator of claim 8,
wherein a fixing member is provided on the rear surface of the panel,
wherein a substrate fixing protrusion protruding backward is formed on the fixing member, and
wherein a substrate hole through which the substrate fixing protrusion penetrates is formed on the substrate to restrain the substrate.

12. The refrigerator of claim 7,
wherein the panel assembly further includes a light guide plate provided at the rear of the panel and guiding light toward the panel, and
wherein the lighting assembly is configured to irradiate light toward an end part of the light guide plate by being spaced apart from at least one side of a perimeter surface of the light guide plate.

13. The refrigerator of claim 12,
wherein the panel assembly includes a plurality of holders disposed along a periphery of the light guide plate and accommodating the end part of the light guide plate to fix the light guide plate,
wherein the lighting assembly is accommodated inside the holder,
wherein the holder is formed of a different material having a different thermal expansion coefficient from that of the light guide plate, and
wherein the plurality of holders are disposed spaced apart from each other.

14. The refrigerator of claim 13,
wherein the holder is formed with a fixing protrusion extending rearwardly so as to pass through a rear surface of the panel assembly, and
wherein the fixing protrusion is coupled with a holder bracket provided on the door body when the panel assembly is mounted on the door body.

15. The refrigerator of claim 7,
wherein a diffusion sheet is attached to the rear surface of the panel, wherein the diffusion sheet is formed to shield all of the plurality of through-holes, and
wherein an inside of the through-holes is filled with a hole-filling member that allows light to pass through.
